(19) United States
(12) Patent Application Publication
(10) Pub. No.: US 2026/0319917 A1
(43) Pub. Date: Oct. 15, 2026

(54) VEHICLE SYSTEM, VEHICLE-EXTERNAL DEVICE, DATA COMMUNICATION SYSTEM, DATA PROCESSING PROGRAM, AND DATA PROCESSING METHOD

(71) Applicant: DENSO CORPORATION, Kariya-city (JP)

(72) Inventors: Yukiyasu YOSHIMURA, Kariya-city (JP); Kazuhiro UEHARA, UEHARA (JP); Yuzo HARATA, Kariya-city (JP)

(21) Appl. No.: 19/689,037

(22) Filed: May 27, 2026

Related U.S. Application Data
(63) Continuation of application No. PCT/JP2024/026640, filed on Jul. 25, 2024.

(30) Foreign Application Priority Data
Nov. 29, 2023 (JP) 2023-201772

(51) Int. Cl. G06F 11/3604; G06F 8/65

(52) U.S. Cl. CPC G06F 11/3608; G06F 8/65

(57) ABSTRACT

A vehicle system implements a functionality by software items in combination. In response to updating software, the vehicle system checks a dysfunction status pertaining to the functionality implemented by the updated software. The vehicle system generates actual-performance data in which a check result of the dysfunction status and software versions of software items implementing the functionality are linked to each other.

### CROSS REFERENCE TO RELATED APPLICATION

This application is a continuation application of International Patent Application No. PCT/JP2024/026640 filed on Jul. 25, 2024, which designated the U.S. and claims the benefit of priority from Japanese Patent Application No. 2023-201772 filed on Nov. 29, 2023. The entire disclosures of all of the above applications are incorporated herein by reference.

### TECHNICAL FIELD

The present disclosure relates to a vehicle system, a vehicle-external device, a data communication system, a data processing program, and a data processing method.

### BACKGROUND

A technology has been provided to update software installed in electronic control units (hereinafter referred to as ECU) of a vehicle in a wireless manner or in a wired manner. For example, there is an OTA (Over The Air) reprogramming configuration for updating software wirelessly.

### SUMMARY

According to an aspect of the present disclosure, a vehicle system implements a functionality by software items in combination. In response to updating software, the vehicle system may check a dysfunction status pertaining to the functionality implemented by the updated software. The vehicle system may generate actual-performance data in which a check result of the dysfunction status and software versions of software items implementing the functionality are linked to each other.

### BRIEF DESCRIPTION OF DRAWINGS

Objects, features and advantages of the present disclosure will become more apparent from the following detailed description made with reference to the accompanying drawings. In the drawings:

FIG. 1 is a diagram illustrating an overall structure of a first embodiment;

FIG. 2 is a diagram illustrating format conversion;

FIG. 3 is a diagram illustrating formatting;

FIG. 4 is a diagram illustrating software arrangement;

FIG. 5 is a functional block diagram of a control unit in a CGW;

FIG. 6 is a functional block diagram of a control unit in an OTA center;

FIG. 7 is a diagram illustrating actual-performance data;

FIG. 8 is a flowchart illustrating a CGW process;

FIG. 9 is a diagram illustrating a functionality update inquiry screen;

FIG. 10 is a diagram illustrating a predictive information notification screen;

FIG. 11 is a flowchart illustrating an OTA center process;

FIG. 12 is a diagram illustrating actual-performance data;

FIG. 13 is a flowchart illustrating an OTA center process;

FIG. 14 is a diagram illustrating actual-performance database;

FIG. 15 is a diagram illustrating a functionality update inquiry screen;

FIG. 16 is a diagram illustrating a survey input screen;

FIG. 17 is a diagram illustrating actual-performance data;

FIG. 18 is a diagram illustrating actual-performance data;

FIG. 19 is a diagram illustrating a predictive information notification screen;

FIG. 20 is a diagram illustrating an actual-performance database;

FIG. 21 is a flowchart illustrating an OTA center process;

FIG. 22 is a diagram illustrating an actual-performance database;

FIG. 23 is a diagram illustrating an actual-performance database;

FIG. 24 is a diagram illustrating an actual-performance database;

FIG. 25 is a diagram illustrating an actual-performance database; and

FIG. 26 is a flowchart illustrating an OTA center process.

### DETAILED DESCRIPTION

For example, with diversification of vehicle controls, such as driving assist functions and automated driving functions, a technology has been provided to update software installed in electronic control units (hereinafter referred to as ECU) of a vehicle in a wireless manner or in a wired manner. For example, there is an OTA (Over The Air) reprogramming configuration for updating software wirelessly.

A vehicle includes a number of ECUs and software items are written to ECUs to implement functionalities. In recent years, a high-performance computer (HPCs) is mounted on a vehicle, and in some cases, multiple software items are written to the HPC. In some cases, software items may have dependencies on each other and various functionalities are implemented by combinations of multiple software items.

For example, because of wide use of OTA, it is expected that software update options will increase, and that software update will be variously executed according to user choice. In the above, a software version combination unexpected by a development vendor may happen and a dysfunction may happen due to an inappropriate combination of software versions. In this regard, verifying software version combinations in advance may be an option.

However, in view of circumstances where separate development vendors design their own ECUs and combinations of software versions are infinite, verifying combinations of software versions may require significant cost and time and may be unrealistic.

The present disclosure provides technology that appropriately addresses dysfunctions that may happen due to inappropriate combinations of software versions.

According an embodiment of the present disclosure, a vehicle system in which a plurality of software items in combination implements a functionality includes: a dysfunction checker unit that, in response to updating software, checks a dysfunction status pertaining to the functionality implemented by the updated software; and an actual-performance data generator unit that generates actual-performance data in which a check result of the dysfunction checker unit and software versions of software items implementing the functionality are linked to each other.

According to an embodiment of the present disclosure, a data processing program causes a control unit of a vehicle system, in which a plurality of software items in combination implements a functionality, to execute: a dysfunction check procedure of, in response to updating software, checking a dysfunction status pertaining to the functionality implemented by the updated software; and an actual-performance data generation procedure of generating actual-performance data in which a check result of the dysfunction check procedure and software versions of software items implementing the functionality are linked to each other.

According to an embodiment of the present disclosure, a data processing method executed in a vehicle system in which a plurality of software items in combination implements a functionality includes: a dysfunction check procedure of, in response to updating software, checking a dysfunction status pertaining to the functionality implemented by the updated software; and an actual-performance data generation procedure of generating actual-performance data in which a check result of the dysfunction check procedure and software versions of software items implementing the functionality are linked to each other.

According to an embodiment of the present disclosure, in response to the software update, the actual performance data is generated in which the check result of the dysfunction status pertaining to the functionality implemented by the updated software and the software versions of the software items implementing the functionality are linked to each other. By generating the actual-performance data at the vehicle system, it is possible to appropriately address dysfunctions that may happen due to inappropriate combinations of software versions.

According to an embodiment of the present disclosure, a vehicle-external device that manages software items for implementing a functionality in a vehicle system includes: an actual-performance database storage unit that stores an actual-performance database including actual-performance data of a plurality of vehicles such that the actual-performance data of a respective vehicle indicates a correspondence between a combination of software versions of software items implementing a functionality in the vehicle system and a dysfunction status pertaining to the functionality; a predictive information generator unit that refers to the actual-performance database to generate predictive information on a prediction of an event that will occur due to an update to an update-planned software item; and a predictive information transmitter unit that causes the predictive information generated by the predictive information generator unit to be transmitted to the vehicle system.

According to an embodiment of the present disclosure, a data processing program causes a control unit of a vehicle-external device, which vehicle-external device manages software items for implementing a functionality in a vehicle system and includes an actual-performance database storage unit that stores an actual-performance database including actual-performance data of a plurality of vehicles such that the actual-performance data of a respective vehicle indicates a correspondence between a combination of software versions of software items implementing a functionality in the vehicle system and a dysfunction status pertaining to the functionality, to execute: a predictive information generation procedure of referring to the actual-performance database to generate predictive information on a prediction of an event that will occur due to an update to an update-planned software item; and a predictive information transmission procedure of causing the predictive information generated by the predictive information generation procedure to be transmitted to the vehicle system.

According to an embodiment of the present disclosure, a data processing method executed in a vehicle-external device that manages software items for implementing a functionality in a vehicle system and includes an actual-performance database storage unit that stores an actual-performance database including actual-performance data of a plurality of vehicles such that the actual-performance data of a respective vehicle indicates a correspondence between a combination of software versions of software items implementing a functionality in the vehicle system and a dysfunction status pertaining to the functionality includes: a predictive information generation procedure of referring to the actual-performance database to generate predictive information on a prediction of an event that will occur due to an update to an update-planned software item; and a predictive information transmission procedure of causing the predictive information generated by the predictive information generation procedure to be transmitted to the vehicle system.

According to an embodiment of the present disclosure, the predictive information on the prediction of the event that will occur due to the update to the update-planned software item is generated by referring to the actual-performance database, and the generated predictive information is transmitted to the vehicle system. By the vehicle-external device generating the predictive information and transmitting the generated predictive information to the vehicle system, it is possible to appropriately address dysfunctions that may happen due to inappropriate combinations of software versions.

According to an embodiment of the present disclosure, a vehicle-external device that manages software items for implementing a functionality in a vehicle system includes: an actual-performance database storage unit that stores an actual-performance database including actual-performance data of a plurality of vehicles such that the actual-performance data of a respective vehicle indicates a correspondence between a combination of software versions of software items implementing a functionality in the vehicle system and a dysfunction status pertaining to the functionality; an actual-performance data acquirer unit that, from the vehicle system, acquires actual-performance data in which a check result of dysfunction status pertaining to a functionality implemented by updated software and software versions of software items implementing the functionality are linked to each other; and an actual-performance database updater unit that updates the actual-performance database when the actual-performance data is acquired by the actual-performance data acquirer unit.

According to an embodiment of the present disclosure, a data processing program causes a control unit of a vehicle-external device, which vehicle-external device manages software items for implementing a functionality in a vehicle system and includes an actual-performance database storage unit that stores an actual-performance database including actual-performance data of a plurality of vehicles such that the actual-performance data of a respective vehicle indicates a correspondence between a combination of software versions of software items implementing a functionality in the vehicle system and a dysfunction status pertaining to the functionality, to execute: an actual-performance data acquisition procedure of, from the vehicle system, acquiring actual-performance data in which a check result of dysfunction status pertaining to a functionality implemented by updated software and software versions of software items implementing the functionality are linked to each other; and an actual-performance database update procedure of updating the actual-performance database when the actual-performance data is acquired by the actual-performance data acquisition procedure.

According to an embodiment of the present disclosure, a data processing method executed in a vehicle-external device that manages software items for implementing a functionality in a vehicle system and that includes an actual-performance database storage unit that stores an actual-performance database including actual-performance data of a plurality of vehicles such that the actual-performance data of a respective vehicle indicates a correspondence between a combination of software versions of software items implementing a functionality in the vehicle system and a dysfunction status pertaining to the functionality includes: an actual-performance data acquisition procedure of, from the vehicle system, acquiring actual-performance data in which a check result of dysfunction status pertaining to a functionality implemented by updated software and software versions of software items implementing the functionality are linked to each other; and an actual-performance database update procedure of updating the actual-performance database when the actual-performance data is acquired by the actual-performance data acquisition procedure.

According to an embodiment of the present disclosure, the actual-performance database is updated upon acquiring, from the vehicle system, the actual-performance data in which the check result of the dysfunction status pertaining to the functionality implemented by the updated software and the software versions of the software items implementing the functionality are linked to each other. By the vehicle-external device updating the actual-performance database upon acquiring the actual-performance data from the vehicle system, it is possible to appropriately address dysfunctions that may happen due to inappropriate combinations of software versions.

According to an embodiment of the present disclosure, a vehicle system in which a plurality of software items in combination implements a functionality includes: a predictive information presenter unit that presents predictive information on a prediction of an event that will occur due to an update to an update-planned software item.

According to an embodiment of the present disclosure, a data processing program causing a control unit of a vehicle system in which a plurality of software items in combination implements a functionality to execute: a predictive information presentation procedure of presenting predictive information on a prediction of an event that will occur due to an update to an update-planned software item.

According to an embodiment of the present disclosure, a data processing method executed in a vehicle system in which a plurality of software items in combination implements a functionality includes: a predictive information presentation procedure of presenting predictive information on a prediction of an event that will occur due to an update to an update-planned software item.

According to an embodiment of the present disclosure, by presenting the predictive information on a prediction of an event that will occur due to an update to an update-planned software item in the vehicle system, it is possible to appropriately address dysfunctions that may happen due to inappropriate combinations of software versions.

According to an embodiment of the present disclosure, a data communication system includes: a vehicle system in which a plurality of software items in combination implements a functionality; and a vehicle-external device that manages the software items implementing the functionality in the vehicle system. The vehicle system includes: a dysfunction checker unit that, in response to updating software, checks a dysfunction status pertaining to the functionality implemented by the updated software; and an actual-performance data generator unit that generates actual-performance data in which a check result of the dysfunction checker unit and software versions of software items implementing the functionality are linked to each other. The vehicle-external device includes: an actual-performance database storage unit that stores an actual-performance database including actual-performance data of a plurality of vehicles such that the actual-performance data of a respective vehicle indicates a correspondence between a combination of software versions of software items implementing a functionality in the vehicle system and a dysfunction status pertaining to the functionality; an actual-performance data acquirer unit that, from the vehicle system, acquires actual-performance data in which a check result of dysfunction status pertaining to a functionality implemented by updated software and software versions of software items implementing the functionality are linked to each other; and an actual-performance database updater unit that updates the actual-performance database when the actual-performance data is acquired by the actual-performance data acquirer unit.

According to an embodiment of the present disclosure, in response to the software update in the vehicle system, the actual-performance data is generated in which the check result of the dysfunction status pertaining to the functionality implemented by the updated software and the software versions of the software items implementing the functionality are linked to each other. With reference to the actual-performance database, the vehicle-external device generates the predicted information on the prediction of the event that will occur due to the update to the update-planned software item. It is possible to appropriately address dysfunctions that may happen due to inappropriate combinations of software versions.

According to an embodiment of the present disclosure, a vehicle-external device that performs management of software items for implementing a functionality in a vehicle system includes: an actual-performance database storage unit that stores an actual-performance database including actual-performance data of a plurality of vehicles such that the actual-performance data of a respective vehicle indicates a correspondence between a combination of software versions of software items implementing a functionality in the vehicle system and an actual-operation record of the functionality in the vehicle system; an actual-performance data acquirer unit that, from the vehicle system, acquires actual-performance data in which an actual-operation record of the functionality implemented by updated software and a combination of software versions of software items implementing the functionality are linked to each other; and an actual-performance database updater unit that updates the actual-performance database when the actual-performance data is acquired by the actual-performance data acquirer unit.

According to an embodiment of the present disclosure, a data processing program causes a control unit of a vehicle-external device, which vehicle-external device performs management of software items for implementing a functionality in a vehicle system and includes an actual-performance database storage unit that stores an actual-performance database including actual-performance data of a plurality of vehicles such that the actual-performance data of a respective vehicle indicates a correspondence between a combination of software versions of software items implementing a functionality in the vehicle system and an actual-operation record of the functionality in the vehicle system, to execute: an actual-performance data acquisition procedure of, from the vehicle system, acquiring actual-performance data in which an actual-operation record of the functionality implemented by updated software and a combination of software versions of software items implementing the functionality are linked to each other; and an actual-performance database update procedure of updating the actual-performance database when the actual-performance data is acquired by the actual-performance data acquisition procedure.

According to an embodiment of the present disclosure, a data processing method executed in a vehicle-external device that performs management of software items for implementing a functionality in a vehicle system and includes an actual-performance database storage unit that stores an actual-performance database including actual-performance data of a plurality of vehicles such that the actual-performance data of a respective vehicle indicates a correspondence between a combination of software versions of software items implementing a functionality in the vehicle system and an actual-operation record of the functionality in the vehicle system includes: an actual-performance data acquisition procedure of, from the vehicle system, acquiring actual-performance data in which an actual-operation record of the functionality implemented by updated software and a combination of software versions of software items implementing the functionality are linked to each other; and an actual-performance database update procedure of updating the actual-performance database when the actual-performance data is acquired by the actual-performance data acquisition procedure.

According to an embodiment of the present disclosure, the actual-performance database is updated upon acquiring, from the vehicle system, the actual-performance data in which the actual-operation record of the functionality implemented by the updated software and the software versions of the software items implementing the functionality are linked to each other. By updating the actual-performance database at the vehicle-external device upon acquiring the actual-performance data from the vehicle system, it is possible to appropriately address dysfunctions that may happen due to inappropriate combinations of software versions.

According to an embodiment of the present disclosure, a vehicle-external device that manages software items for implementing a functionality in a vehicle system includes: an actual-performance database storage unit that stores an actual-performance database including actual-performance data of a plurality of vehicles such that the actual-performance data of a respective vehicle indicates a correspondence between a combination of software versions implementing a functionality in the vehicle system and an operation log of the functionality in the respective vehicle; and an actual-performance data acquirer unit that, from the vehicle system, acquires actual-performance data in which an operation log of the functionality implemented by updated software and software versions of software items implementing the functionality are linked to each other; and an actual-performance database updater unit that updates the actual-performance database when the actual-performance data is acquired by the actual-performance data acquirer unit.

According to an embodiment of the present disclosure, a data processing program causes a control unit of a vehicle-external device, which vehicle-external device manages software items for implementing a functionality in a vehicle system and includes an actual-performance database storage unit that stores an actual-performance database including actual-performance data of a plurality of vehicles such that the actual-performance data of a respective vehicle indicates a correspondence between a combination of software versions implementing a functionality in the vehicle system and an operation log of the functionality in the respective vehicle, to execute: an actual-performance data acquisition procedure of, from the vehicle system, acquiring actual-performance data in which an operation log of the functionality implemented by updated software and software versions of software items implementing the functionality are linked to each other; and an actual-performance database update procedure of updating the actual-performance database when the actual-performance data is acquired by the actual-performance data acquisition procedure.

According to an embodiment of the present disclosure, a data processing method executed in a vehicle-external device that manages software items for implementing a functionality in a vehicle system and includes an actual-performance database storage unit that stores an actual-performance database including actual-performance data of a plurality of vehicles such that the actual-performance data of a respective vehicle indicates a correspondence between a combination of software versions implementing a functionality in the vehicle system and an operation log of the functionality in the respective vehicle includes: an actual-performance data acquisition procedure of, from the vehicle system, acquiring actual-performance data in which an operation log of the functionality implemented by updated software and software versions of software items implementing the functionality are linked to each other; and an actual-performance database update procedure of updating the actual-performance database when the actual-performance data is acquired by the actual-performance data acquisition procedure.

According to an embodiment of the present disclosure, the actual-performance database is updated upon acquiring, from the vehicle system, the actual-performance data in which the operation log of the functionality implemented by the updated software and the software versions of the software items implementing the functionality are linked to each other. By updating the actual-performance database at the vehicle-external device upon acquiring the actual-performance data from the vehicle system, it is possible to appropriately check the operation logs of the functionality implemented by the updated software. Also, by analyzing the operation log, it is possible to ascertain in what timing an abnormality or failure occurred.

In the below, detailed description of embodiments of the present disclosure will be given with reference to the drawings. In a later described embodiment, description of the same part as in a preceding embodiment may be omitted.

### First Embodiment

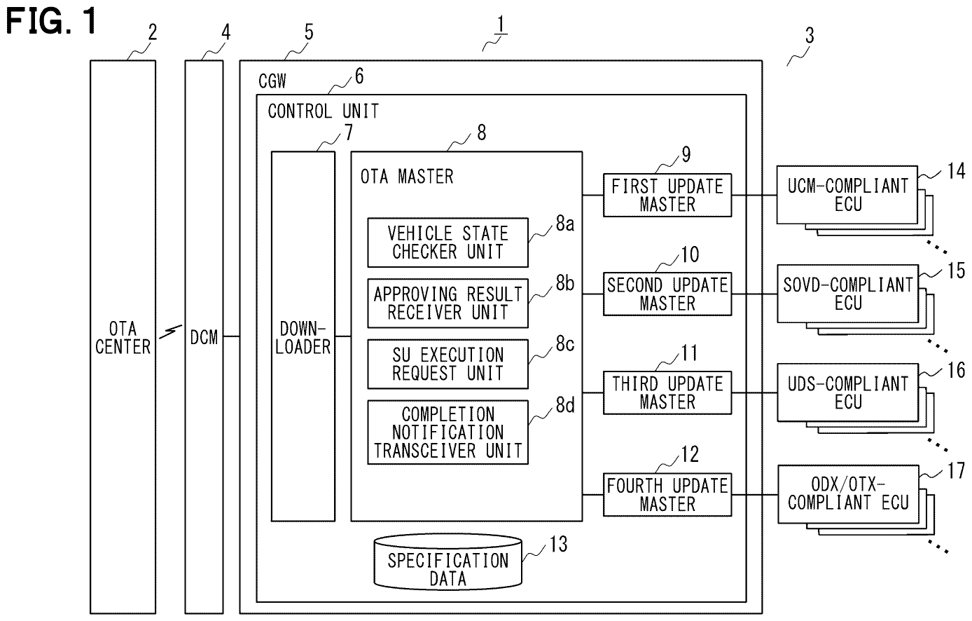

A first embodiment will be described with reference to FIG. 1 to FIG. 15. As shown in FIG. 1, a data communication system 1 includes an OTA center 2 (corresponding to a vehicle-external device) and a vehicle system 3. The vehicle system 3 includes a DCM (Data Communication Module) 4, a CGW (Central Gateway) 5, and ECUs 14 to 17 described below. The DCM 4 is an in-vehicle communication device and performs data communication with the OTA center 2 via a communication network. The communication network includes a mobile communication network, for example, 4G, 5G, the Internet, WiFi (Wireless Fidelity) (registered trademark), etc. The DCM 4 and the CGW 5 may be integrated so that the functions of the DCM 4 are incorporated into the CGW 5. The functions of the DCM 4 and/or the function of CGW 5 may be incorporated into a display or other devices.

To the CGW 5, the DCM 4 forwards data delivered from the OTA center 2. The data delivered from the OTA center 2 to DCM 4 is, for example, reprogramming software. An SOVD format compliant with SOVD communication specifications or a RestAPI format compliant with to Rest (REpresentational State Transfer) API communication specifications is applied to center communication which is data communication between the OTA center 2 and the CGW 5.

The CGW 5 includes a control unit 6. The control unit 6 includes, as its main component, a microcomputer (hereinafter referred also to as “microcomp”) including a CPU, a ROM, a RAM, an I/O, etc., and controls the operation of the CGW 5 via executing software processing by the CPU executing a computer program stored in a non-transitory tangible storage medium, and via executing hardware processing by a dedicated electronic circuit.

The CGW 5 may provide an HPC. The CGW 5 may include, for example, a System-on-Chip (SoC) as its hardware and an Adaptive Platform as its software. The CGW 5 may include multiple VMs (Virtual Machines), and the multiple VMs may include VMs of various Platforms, e.g., a VM of the Adaptive Platform and a VM of a Classic Platform. The CGW 5 may function as so-called a vehicle computer in an E-E architecture of a vehicle, for example.

On a function basis, the control unit 6 includes a downloader 7, an OTA master 8, a first update master 9, a second update master 10, a third update master 11, a fourth update master 12, and a specification data retention unit 13. Upon receipt of a download execution request from the OTA master 8, the downloader 7 commands the DCM 4 to execute a download process. The downloader 7 downloads data from OTA center 2 via the DCM 4 such that the data delivered from OTA center 2 is received at the DCM 4 and the received data is forwarded.

The OTA master 8 has a function responsible for overall management of SU (Software Update). On a function basis, the OTA master 8 includes a vehicle state checker unit 8a, an approving result receiver unit 8b, an SU execution requester unit 8c, and a completion notification transceiver unit 8d.

The vehicle state checker unit 8a, for example, acquires a vehicle state from a software update target ECU and checks the vehicle state. The approving result receiver unit 8b receives an approving result as to execution of a download process, execution of an installation process, and execution of an activation process from an in-vehicle HMI (Human Machine Interface) (not shown), for example, in the process of software update.

Upon satisfaction of an installation execution condition, e.g., upon getting an approval to execute the installation process, the SU execution requester unit 8c outputs an installation execution request to an appropriate update master among the update masters 9 to 12. Upon receipt of the installation execution request from the SU execution requester unit 8c, the update master commands the software update target ECU to execute the installation process. Upon being commanded to execute the installation process, the software update target ECU executes the installation process. Examples of software updates are various including firmware updates in units of ECU, and updates in units of such software in an ECU as application, library, etc.

Upon satisfaction of an activation execution condition, e.g., upon getting an approval to execute the activation process, the SU execution requester unit 8c outputs an activation execution request to an appropriate update master among the update masters 9 to 12. Upon receipt of the activation execution request from the SU execution requester unit 8c, the update master commands the software update target ECU to execute the activation process. Upon being commanded to execute the activation process, the software update target ECU executes the activation process.

Upon receipt of an installation completion notification from the software update target ECU, the completion notification transceiver unit 8d causes the DCM 4 to transmit an installation completion notification to the OTA center 2. Upon receipt of an activation completion notification from the software update target ECU, the completion notification transceiver unit 8d causes the DCM 4 to transmit an activation completion notification to the OTA center 2.

Next, the update master 9 to 12 will be described. The ECUs 14 to 17, respectively, are connected to the update masters 9 to 12 via in-vehicle networks. Examples of the in-vehicle networks include CAN (Controller Area Network), Ethernet (registered trademark), etc.

The first update master 9 is connected to a UCM (Update & Configuration Management) compliant ECU 14 via the in-vehicle network. The first update master 9 performs data communication with the UCM compliant ECU 14 in line with commands from the OTA master 8. A UCM format complaint with UCM communication specifications is applied to ECU communication which is data communication between the first update master 9 and the UCM compliant ECU 14. The UCM format is a format defined in AUTOSAR. The UCM compliant ECU 14 implements, for example, UI (User Interface) services and MM (MultiMedia) services. The functions of the first update master 9 may be provided in the UCM compliant ECU 14.

The UCM compliant ECU 14 may provide so-called an HPC. The UCM compliant ECU 14 may include, for example, a SoC as its hardware and Adaptive Platform as its software. The UCM compliant ECU 14 may incudes multiple VMs, and the multiple VMs may include VMs of various Platforms, e.g., a VM of Adaptive Platform and a VMs of Classic Platform. The Classic Platform VM may be configured as an UDS compliant VM. The UCM compliant ECU 14 may, for example, function as so-called a domain controller or a zone ECU in the vehicle E-E architecture.

The second update master 10 is connected to the SOVD compliant ECU 15 via the in-vehicle network. The second update master 10 performs data communication with the SOVD compliant ECU 15 in line with commands from the OTA master 8. The SOVD format compliant with SOVD communication specifications is applied to ECU communication which is data communication between the second update master 10 and the SOVD compliant ECU 15. The SOVD format is a format written in JSON (JavaScript Object Notation). The SOVD compliant ECU 15 implements ADAS (Advanced Driving Assistant System) system services. The functions of the second update master 10 may be provided in the SOVD compliant ECU 15.

The SOVD compliant ECU 15 may provide so-called an HPC. The SOVD compliant ECU 15 may, for example, include a SoC as its hardware and Adaptive Platform as its software. The SOVD compliant ECU 15 may include multiple VMs, and the multiple VMs may include VMs of various Platforms, e.g., a VM of Adaptive Platform and a VM of Classic Platform. The Classic Platform VM may be configured as an UDS compliant VM. The SOVD compliant ECU 15 may, for example, function as so-called a domain controller or a zone ECU in the vehicle E-E architecture.

The third update master 11 is connected to a UDS (Unified Diagnostic Services) compliant ECU 16 via the in-vehicle network. The third update master 11 performs data communication with the UDS compliant ECU 16 in line with the commands from the OTA master 8. A UDS format compliant with UDS communication specifications is applied to ECU communication which is data communication between the third update master 11 and the UDS compliant ECU 16. The UDS format is an OEM-dependent format. The UDS compliant ECU implements engine-system services, hybrid (HV) system services, electric vehicle (EV) services.

The UDS compliant ECU 16 may, for example, include an MCU (Micro Controller Unit) as its hardware and Classic Platform as its software.

An ODX (Open Diagnostic Data Exchange)/OTX (Open Test Sequence Exchange) compliant ECU 17 is connected to the fourth update master 12 via the in-vehicle network. The fourth update master 12 performs data communication with the ODX/OTX compliant ECU 17 in line with commands from the OTA master 8. An ODX/OTX format compliant with ODX/OTX communication specifications is applied for ECU communication which is data communication between the fourth update master 12 and the ODX/OTX compliant ECU 17. The ODX/OTX format is a format written in XML (eXtensible Markup Language).

The ODX/OTX compliant ECU 17 may, for example, include an MCU as its hardware and Classic Platform as its software.

Functions of the respective update masters 9 to 12 may be provided in the CGW 5 or in the ECUs 14 to 17. The function of the update master 9 to 12 may be provided in an ECU in the vehicle other than the CGW 5 and the ECU 14 to 17. When the functions of the update masters 9 to 12 are provided in the ECUs 14 to 17 respectively, the update masters 9 to 12 are connected to and communicate with specific software components within the ECUs 14 to 17. For example, when the first update master 9 is provided in the UCM compliant ECU 14, the first update master 9 is connected to and communicates with a UCM-responsible software component within the UCM compliant ECU 14. For example, when the second update master 9 is provided in the SOVD compliant ECU 15, the second update master 9 is connected to and communicates with a SOVD-responsible software component within the SOVD compliant ECU 15.

Specification data retained in the specification data retention unit 13 includes various information on software update, such as information on output targets and output sequence of installation commands and information on output targets and output sequence of activation commands.

The update master 9 to 12 has a format conversion function of converting the format in the center communication according to specifications of a corresponding ECU, and a formatting function of forming the format for the center communication from the format in the ECU communication with the corresponding ECU.

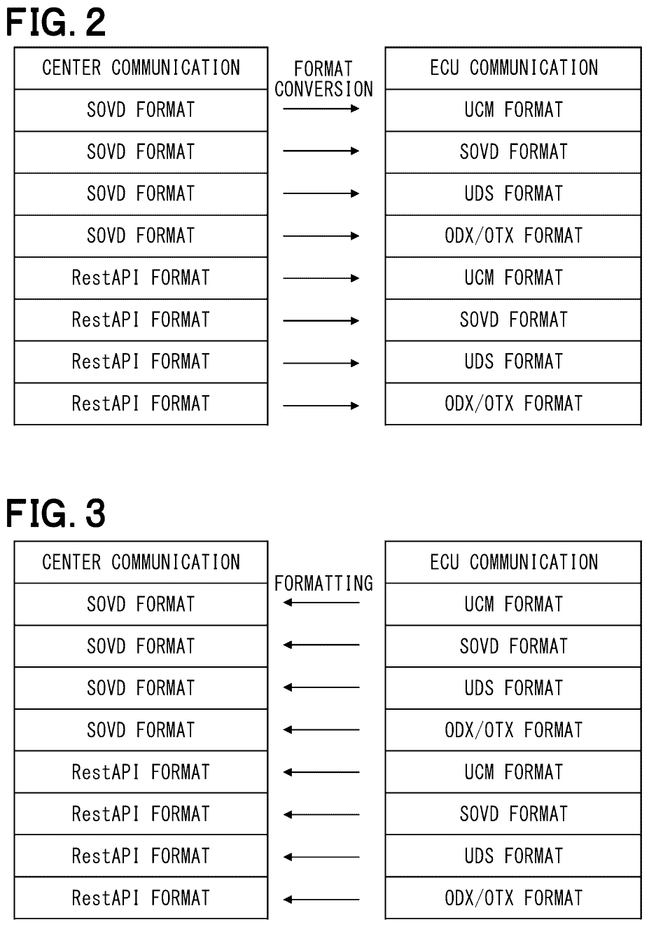

The format conversion function will be described with reference to FIG. 2. Because the first update master 9 performs the ECU communication with the UCM compliant ECUs 14 according to the UCM communication specifications, the first update master 9 converts the format in the center communication to the UCM format. The first update master 9 converts the SOVD format to the UCM format if the center communication is in the SOVD format. The first update master 9 converts the RestAPI format to the UCM format if the center communication is in the RestAPI format. If the center communication is in the RestAPI format, the RestAPI format may be converted to the SOVD format at the downloader 7 or the OTA master 8, and the SOVD format may be converted to the UCM format at the first update master 9.

Because the second update master 10 performs the ECU communication with the SOVD compliant ECU 15 according to the SOVD communication specifications, the second update master 10 converts the format in the center communication to the SOVD format as necessary. If the center communication is in the SOVD format, the second update master 10 applies the SOVD format without converting the SOVD format. If the center communication is in the RestAPI format, the second update master 10 converts the RestAPI format to the SOVD format. If the center communication is in the RestAPI format, the RestAPI format may be converted to the SOVD format at the downloader 7 or the OTA master 8.

Because the third update master 11 performs the ECU communication with the UDS compliant ECU 16 according to the UDS communication specifications, the third update master 11 converts the format in the center communication to the UDS format. If the center communication is in the SOVD format, the third update master 11 converts the SOVD format to the UDS format. If the center communication is in the RestAPI format, the third update master 11 converts the RestAPI format to the UDS format. If the center communication is in the RestAPI format, the RestAPI format may be converted to the SOVD format at the downloader 7 or the OTA master 8 and the SOVD format may be converted to the UDS format at the third update master 11.

Because the fourth update master 12 performs the ECU communication with the ODX/OTX compliant ECU 17 according to the ODX/OTX communication specifications, the fourth update master 12 performs format conversion for the center communication with the ODX/OTX format. The fourth update master 12 converts the SOVD format with the ODX/OTX format if the center communication is in the SOVD format. The fourth update master 12 converts the RestAPI format with the ODX/OTX format if the center communication is in the RestAPI format. If the center communication is in the RestAPI format, the RestAPI format may be converted to the SOVD format at the downloader 7 or the OTA master 8, and the SOVD format may be converted with the ODX/OTX format at the fourth update master 12.

The formatting function will be described with reference to FIG. 3. Because the first update master 9 performs the ECU communication with the UCM compliant ECUs 14 according to the UCM communication specifications, the first update master 9 forms the format for the center communication from the UCM format. If the center communication is in the SOVD format, the first update master 9 forms the SOVD format from the UCM format. If the center communication is in the RestAPI format, the first update master 9 forms the RestAPI format from the UCM format.

Because the second update master 10 performs the ECU communication with the SOVD compliant ECU 15 according to the SOVD communication specifications, the second update master 10 forms the format for the center communication from the SOVD format as necessary. If the center communication is in the SOVD format, the second update master 10 applies the SOVD format without forming the SOVD format. If the center communication is in the RestAPI format, the second update master 10 forms the RestAPI format from the SOVD format.

Because the third update master 11 performs the ECU communication with the UDS compliant ECU 16 according to the UDS communication specifications, the third update master 11 forms the format for center communication from the UDS format. If the center communication is in the SOVD format, the third update master 11 forms the SOVD format from the UDS format. If the center communication is in the RestAPI format, the third update master 11 forms the RestAPI format from the UDS format.

Because the fourth update master 12 performs the ECU communication with the ODX/OTX compliant ECUs 17 according to the ODX/OTX communication specifications, the fourth update master 12 forms the format for the center communication with the ODX/OTX format. If the center communication is in the SOVD format, the fourth update master 12 forms the SOVD format with the ODX/OTX format. If the center communication is in the RestAPI format, the fourth update master 12 forms the RestAPI format with the ODX/OTX format.

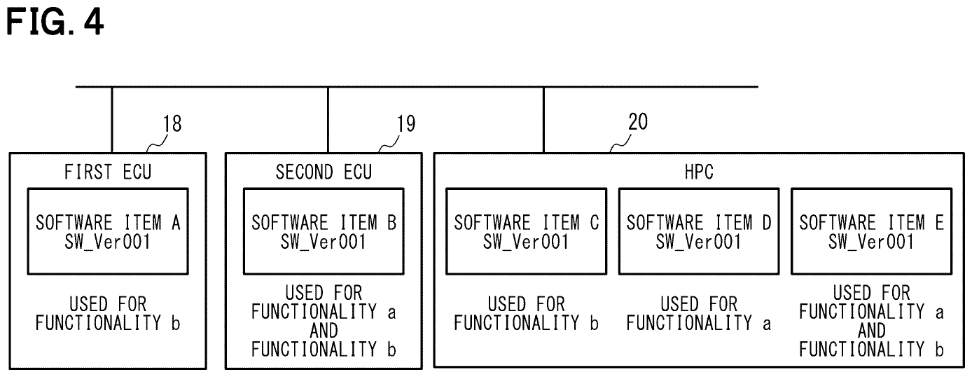

Next, software written to ECUs and HPCs will be described. Software items to implement functionalities are written in the ECUs and the HPCs, and these software items have dependencies on each other, so that software items in combination implement a variety of functionalities. FIG. 4 shows an example in which the first ECU 18 has a written software item A, the second ECU 19 has a written software item B, and the HPC 20 has a written software item C, a written software item D and a written software item E. Each of the first ECU 18, the second ECU 19, and the HPC 20 correspond to any one of the ECUs 14 to 17 described in FIG. 1.

The software items B, D, and E are used for a functionality “a”, and the software items A, B, C, and E are used for a functionality “b”. Specifically, the functionality a is achieved by cooperation of the software items B, D, and E, and the functionality b is achieved by cooperation of the software items A, B, C, and E. Where a functionality is achieved by the cooperation of multiple software items, if a software version combination beyond development vendor's assumption may happen, an inappropriate combination of software versions may cause a dysfunction. In this regard, the OTA center 2 and the vehicle system 3 cooperate to manage dysfunctions that may happen due to combinations of software versions.

For example, in the vehicle equipped with multiple functionalities each implemented by multiple software items, there may be a software item common between multiple software items implementing a first functionality and multiple software items implementing a second functionality. Specifically, there may be a software item used by both the first functionality and the second functionality. In such cases, updating the first functionality may change the software version combination of the second functionality. In the example in FIG. 4, the software items B and E are software items used by both the functionality “a” and the functionality “b”. For example, updating the functionality “a” that includes updating the software item B, E changes the software version combination of the functionality “b”. In this case, the combination of software versions of the functionality “b” may become, for example, a combination beyond the development vendor's assumption, and an inappropriate combination of software versions may cause a dysfunction.

In the below, managing dysfunctions that may happen due to combination of software versions will be described. Processes for managing dysfunctions include a process for the vehicle system 3 to generate actual-performance data, a process for the OTA center 2 to transmit predictive information to the vehicle system 3, a process for the OTA center 2 to update an actual-performance database, and a process for the vehicle system 3 to present the predictive information.

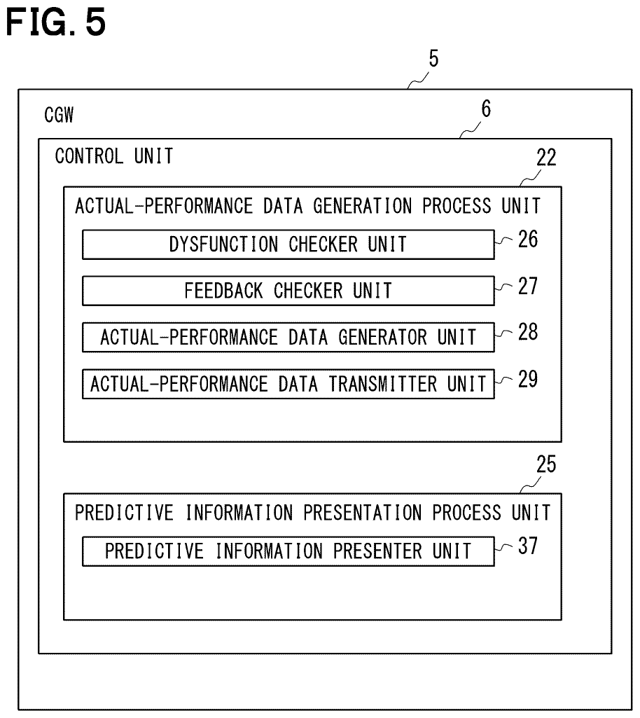

As shown in FIG. 5, the control unit 6 of the CGW 5 includes an actual-performance data generation process unit 22 which executes a process of generating the actual-performance data, and a predictive information presentation process unit 25 which executes a process of presenting the predictive information. The control unit 6 executes a data processing program for the vehicle system 3 as a computer program by these actual-performance data generation process unit 22 and predictive information presentation process unit 25. In addition, a data processing method of the vehicle system 3 is executed by execution of the data processing program of the vehicle system 3 by the control unit 6.

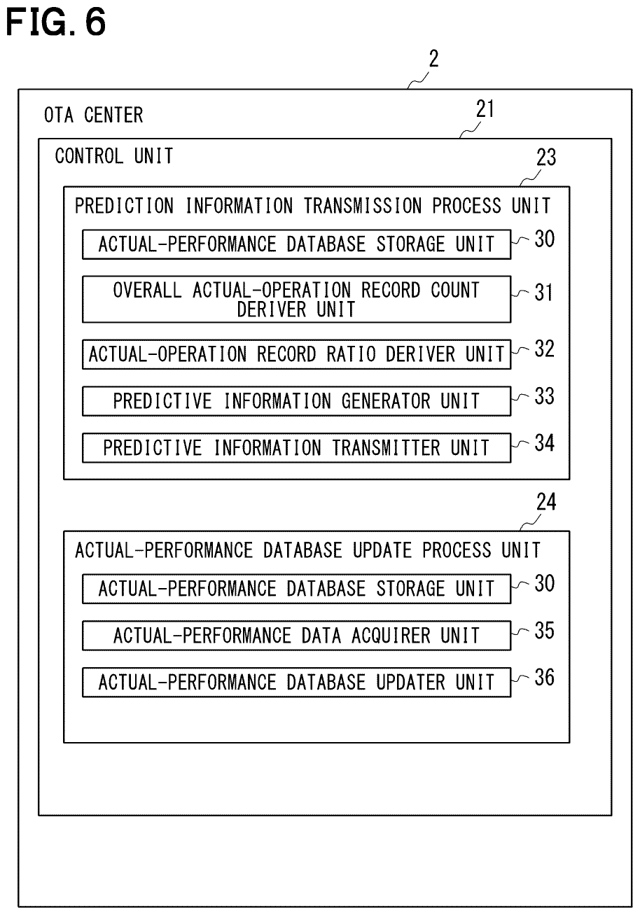

As shown in FIG. 6, the OTA center 2 includes a control unit 21. The control unit 21 includes, as its main component, a microcomputer including a CPU, a ROM, a RAM, an I/O, etc., and executes control by software processing via the CPU executing a computer program stored in a non-transitory tangible storage medium and control via hardware processing by a dedicated electronic circuit, so that the operation of the OTA center 2 is controlled.

The control unit 21 includes a predictive information transmission process unit 23 which executes a process of transmitting the predictive information to the vehicle system 3 and an actual-performance database update process unit 24 which executes a process of updating the actual-performance database. The control unit 21 executes a data processing program for a vehicle-external device as a computer program by these predictive information transmission process unit 23 and actual-performance database update process unit 24. A data processing method of the vehicle-external device is executed by execution of the data processing program of the vehicle-external device by the control unit 21.

The actual-performance data generation process unit 22 includes a dysfunction checker unit 26, a feedback checker unit 27, an actual-performance data generator unit 28, and an actual-performance data transmitter unit 29. Upon updating software, the dysfunction checker unit 26 checks a status of dysfunction pertaining to the functionality implemented by the updated software. Upon updating one or more software items for the first functionality software, the dysfunction checker unit 26 checks a dysfunction status pertaining to the first functionality and further checks a dysfunction status pertaining to the second functionality having a software version combination that has changed due to updating the one or more software items. Upon updating one or more software items for the first functionality software, the dysfunction checker unit 26 checks the dysfunction statuses pertaining to multiple functionalities including the first functionality.

In the case of the software item combination shown in FIG. 4 for example, when: the software version of the software item B has changed from “Ver. 001” to “Ver. 002”; the software version of the software item D has changed from “Ver. 001” to “Ver. 002”; and the software version of the software item E has changed from “Ver. 001” to “Ver. 003” with respect to the functionality “a”, the dysfunction checker unit 26 checks whether or not a dysfunction may occur with respect to the functionality “a” and further checks whether a dysfunction may occur with respect to the functionality “b” because the software item B and the software item E are associated with the functionality “b”.

The feedback checker unit 27 checks status of user feedback on usability in response to updating the software. Upon checking the dysfunction by the dysfunction checker unit 26, the actual-performance data generator unit 28 generates the actual-performance data in which the check result and the software versions of software items implementing the functionality are linked to each other. Upon generating the actual-performance data by the actual-performance data generator unit 28, the actual-performance data transmitter unit 29 causes the generated actual-performance data to be transmitted from the DCM 4 to the OTA center 2.

The predictive information presentation process unit 25 includes a predictive information presenter unit 37. The predictive information presenter unit 37 presents the predictive information on a prediction of an event that may occur due to updating an update-planned software item.

The predictive information transmission process unit 23 includes an actual-performance database storage unit 30, an overall actual-operation record count deriver unit 31, an actual-operation record ratio deriver unit 32, a predictive information generator unit 33, and a predictive information transmitter unit 34.

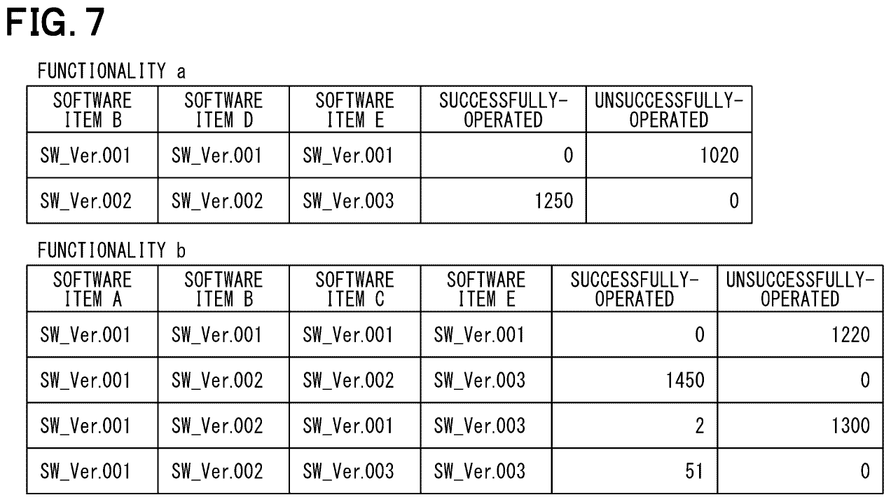

The actual-performance database storage unit 30 stores an actual-performance database including the actual-performance data for multiple vehicles such that the actual-performance data for a respective vehicle indicates a correspondence between a software version combination implementing a functionality in the vehicle system 3 and the dysfunction status pertaining to the functionality. In the case of the software item combination shown in FIG. 4, the actual-performance database storage unit 30 stores, as shown in FIG. 7, the actual-performance data indicating the correspondence relationship of whether the functionality “a” has successfully operated with a combination of software versions of software items B, D, and E, and indicating the correspondence relationship of whether the functionality “b” has successfully operated with a combination of software versions of software items A, B, C, and E.

In FIG. 7, each value for “successfully-operated” and “unsuccessfully-operated” refers to the count of actual-operation records. The “successfully-operated” means that the functionality has normally been achieved by the combination of software items. For example, in a case of a functionality relating to vehicle driving, it means that all functions including acceleration, deceleration, stopping, turning, etc., have normally worked. For example, in a case of a navigation functionality not relating to vehicle driving, it means that all functions including map display, positioning, destination setting, map display, route search, and route guidance have worked normally. The “unsuccessfully-operated” means that the functionality has not normally been achieved by the combination of software items. For example, in the case of the functionality relating to vehicle driving, it means that at least part of functions of acceleration, deceleration, stopping, turning, etc., has not normally worked. For example, in the case of the navigation functionality not relating to vehicle driving, it means that at least part of functions of map display, positioning, destination setting, map display, route search, and route guidance has not worked normally.

In the example in FIG. 7, with respect to the functionality “a”, in the combination of software versions “Ver. 001”, “Ver. 001”, and “Ver. 001” of the software items B, D, and E, the count of actual-operation records “successfully-operated” is 0 and is significantly smaller than the count of actual-operation records “unsuccessfully-operated” which is 1020, indicating unsuccessful-operation and dysfunction occurrence. In the combination of software versions “Ver. 002”, “Ver. 002”, and “Ver. 003” of the software items B, D, and E, the count of actual-operation records “successfully-operated” is 1250 and is significantly larger than the count of actual-operation records “unsuccessfully-operated” which is 0, indicating successful-operation and dysfunction absence.

Likewise, with respect to the functionality “b”, in the combination of software versions “Ver. 001”, “Ver. 001”, “Ver. 001”, and “Ver. 001” of the software items A, B, C, and E, the count of actual-operation records “successfully-operated” is 0 and is significantly smaller than the count of actual-operation record “unsuccessfully-operated” which is 1220, indicating unsuccessful-operation and dysfunction occurrence. In the combination of software versions “Ver. 001,” “Ver. 002,” “Ver. 002,” and “Ver. 003” of the software items A, B, C, and E, the count of actual-operation records “successfully-operated” is 1450 and is significantly larger than the count of actual-operation records “unsuccessfully-operated” which is 0, indicating successful-operation and dysfunction absence.

The overall actual-operation record count deriver unit 31 derives a count of overall actual-operation records in the actual-performance database. With respect to the functionality “a” for example, the overall actual-operation record count deriver unit 31 derives “1020” as the count of overall actual-operation records for the combination of software versions “Ver. 001”, “Ver. 001”, and “Ver. 001” of the software items B, D, and E.

The actual-operation record ratio deriver unit 32 derives the ratio of the count of actual-operation records for the dysfunction absence/absence in the actual-performance database. With respect to the functionality “a” for example, in the combination of software versions “Ver. 001”, “Ver. 001”, and “Ver. 001” of the software items B, D, and E, the actual-operation record ratio deriver unit 32 derives “0%” as the ratio of the count of actual-operation records for the dysfunction absence and 100%” as the ratio of the count of actual-operation records for the dysfunction presence.

The predictive information generator unit 33 refers to the actual-performance database and generates the predictive information on a prediction of an event that may occur due to updating an update-planned software item. As the predictive information, the predictive information generator unit 33 generates information indicating that the functionality implemented by the update-planned software may operate normally or information indicating that a dysfunction of the functionality implemented by the update-planned software may occur. As the predictive information, the predictive information generator unit 33 generates the information indicating a possibility that a dysfunction of the functionality implemented by the update-planned software may occur, together with information indicative of encouraging a different software update for avoiding the dysfunction. In addition, the predictive information generator unit 33 generates information indicating user feedback on usability as the predictive information.

When the predictive information is generated by the predictive information generator unit 33, the predictive information transmitter unit 34 causes the generated predictive information to be transmitted to the vehicle system 3.

The actual-performance database update process unit 24 includes an actual-performance database storage unit 30, an actual-performance data acquirer unit 35, and an actual-performance database updater unit 36.

From the vehicle system 3, the actual-performance data acquirer unit 35 acquires the actual-performance data in which the check result of the dysfunction status pertaining to the functionality implemented by the updated software and the software versions of the software items implementing the functionality are linked to each other. Upon the actual-performance data acquirer unit 35 acquiring the actual-performance data, the actual-performance database updater unit 36 updates the actual-performance database stored in the actual-performance database storage unit 30.

For each of the functionalities of the vehicle, the control unit 6 in the CGW 5 stores and manages multiple software items implementing a respective functionality and a current software version combination of the multiple software items. In a form of list for example, the information on multiple software items implementing a respective functionality is stored in a nonvolatile memory of the control unit 6 as in-vehicle software management information. For example, the control unit 6 inquires each ECU in the vehicle about the current software item that the ECU has and its software version and acquires it for a current software version combination of each functionality, and records in the in-vehicle software management information mentioned above.

Before updating a certain one functionality, the control unit 6 specifies, for each of the multiple functionalities, what software version combination will happen after updating the certain one functionality. For example, the control unit 6 specifies the software item whose software version will change, based on: multiple software items implementing the certain one functionality; the software version of each software item of the certain one functionality before the update; and the software version of each software item of the certain one functionality after the update. Before updating the certain one functionality, the control unit 6 checks a functionality that uses the specified software item by using the in-vehicle software management information and specifies, for each of the multiple functionality, what combination of software versions will happen after updating the certain one functionality. In this way, the control unit 6 specifies: one or more different functionalities whose software version combination will change due to updating the certain one functionality; and what software version combination will happen in the one or more different functionalities due to the change.

By using information acquired from the OTA center 2, the control unit 6 may specify the software version of each software item that the certain one functionality will have after the update. For example, when acquiring information from the OTA center 2 indicating that an update of the certain one functionality is available, the control unit 6 may acquire information indicative of the software version of each software item that the certain one functionality will have after the update.

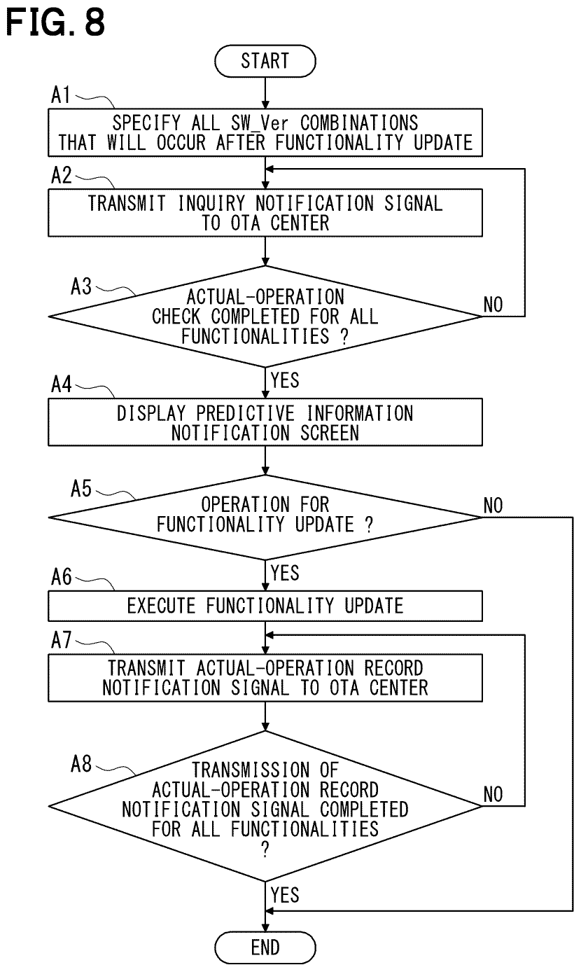

Operations of the configuration will be described with reference to FIG. 8 to FIG. 12. A vehicle process performed by the CGW 5 and A center process performed by OTA center 2 will be described in turn.

### (1) Vehicle Process Performed by CGW 5 (See FIGS. 8 to 10).

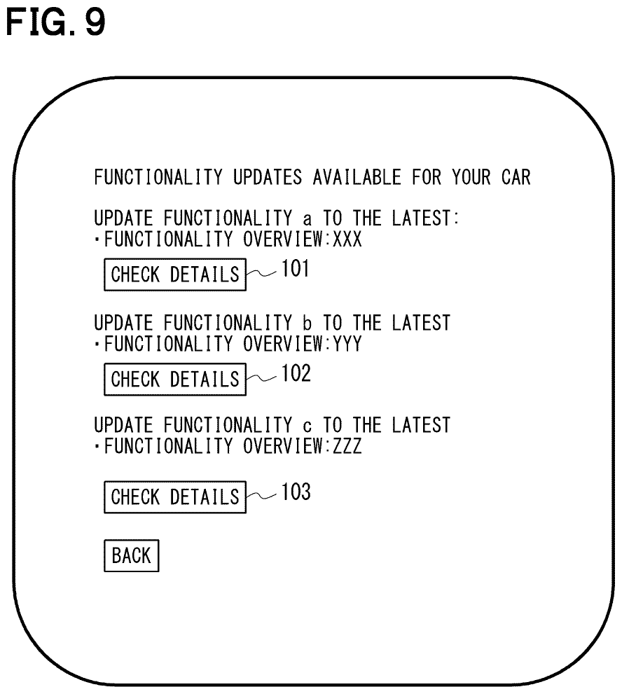

In the CGW 5, the control unit 6 displays a functionality update inquiry screen shown in FIG. 9 in the timing, for example, when the user gets on or gets off the vehicle. In the functionality update inquiry screen, the control unit 6 displays a message “functionality update available for your car” and displays a functionality overview for each update-target functionality”, as well as “check details” buttons 101 to 103. The user can make a choice of the functionality he/she wishes to update, by operating any of the “check details” buttons 101 to 103. When the user operates any of the “check details” buttons 101 to 103, the control unit 6 starts the vehicle process and specifies all software version combinations that will happen after the update (A1).

In detail, when the user operates any of the “Check details” buttons 101 to 103, the control unit 6 specifies, for all the multiple functionalities of the vehicle, the combination of software versions that a respective functionality will have after updating the functionality corresponding to the button operated by the user (hereinafter referred to as the user-selected functionality) by the above-described method for example. At this time, the control unit 6 also specifies one or more different functionalities influenced by the update of the user-selected functionality, as well as the software version combinations of the one or more different functionalities after the update of the user-selected functionality. The one or more different functionalities influenced by updating the user selected functionality is, in the present embodiment, one or more different functionalities whose software version combination will change due to updating the user-selected functionality. If the control unit 6 specifies that the functionality influenced by the update of the user selected functionality is absent, the control unit 6 moves from step A1 to A4 without performing A2 and A3.

When the user operates the “check details” button 101 corresponding to the functionality “a” for example, the control unit 6 specifies the software version combination of software items B, D, and E implementing the functionality “a” both before and after the update of the functionality “a”. The control unit 6 also specifies the software item whose software version will change due to the update of the functionality “a” and specifies whether updating the functionality “a” leads to a change in the software version combination of the software items A, B, C, and E implementing the functionality “b”. When updating the functionality “a” includes updating the software item B and/or the software item E, the control unit 6 specifies that updating the functionality “a” leads to the change in the software version combination of the functionality “b”.

Upon specifying all the software version combinations that will happen after the functionality update, the control unit 6 causes the DCM 4 to transmit an inquiry notification signal to the OTA center 2 to inquire about the predictive information based on the software version combinations (A2) and waits to receive a predictive information notification signal from the OTA center 2. In the present embodiment, the control unit 6 causes the DCM 4 to transmit an inquiry notification signal to the OTA center 2 to inquire about the predictive information for the one or more different functionalities influenced by the update of the user-selected functionality. The inquiry notification signal designates an inquiry-target functionality and a software version combination of the inquiry-target functionality after the update. If there are two or more different functionalities influenced by the update of the user selected functionality, the control unit 6 treats each of the different functionalities as the inquiry-target functionality to cause the DCM 4 to transmit the inquiry notification signal to the OTA center 2. That is, for each inquiry-target functionality, the control unit 6 performs steps A2 and A3.

Upon receipt at the DCM 4 of the predictive information notification signal delivered from the OTA center 2, the control unit 6 acquires an answer from the OTA center 2. The control unit 6 determines whether or not an actual-operation record check is completed for all the functionalities (A3).

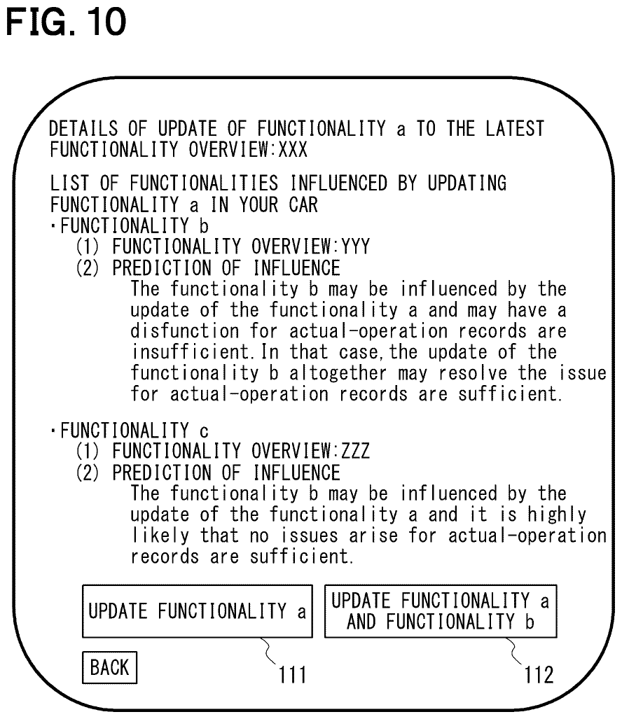

Specifically, the control unit 6 determines whether or not the answer to the inquiry has been received from the OTA center 2 for all of the inquiry target functionalities. The answer to the inquiry includes a prediction of an influence of the update of the user-selected functionality on the inquiry target functionality, wherein the prediction is made by the above-mentioned predictive information generator unit 33 referring to the actual-performance database. Specifically, the answer to the inquiry includes an operation prediction of whether the inquiry target functionality having the post-update software version combination designated in the inquiry notification signal is predicted to operate normally or is likely to have a dysfunction, etc. The answer to the inquiry may also include the functionality overview for the inquiry target functionality (corresponding to functionality overviews for the functionality “b” and the functionality “c” shown in FIG. 10).

If the control unit 6 determines that the actual-operation record check is not completed for all the functionalities (A3: NO), the process returns to step A2 and repeats step A2 for the functionality for which the actual-operation record check is not completed.

When the control unit 6 determines that the actual-operation record check is completed for all the functionalities (A3: YES), the control unit 6 displays a predictive information notification screen shown in FIG. 10 (A4, corresponding to a predictive information presentation procedure) and waits for an operation for the functionality update. Contents of the predictive information notification screen include the prediction of the influence of the update of the user-selected functionality on the one or more different functionalities. Specifically, the contents of the predictive information notification screen include a prediction as to how the one or more different functionalities whose software version combination changes due to updating the user-selected functionality will operate after updating the user-selected functionality. This prediction is contained in the answer-to-inquiry acquired from the OTA center 2 in step A2, A3.

FIG. 10 shows an example of the predictive information notification screen when the user operates the “check details” button 101 corresponding to the functionality “a” on the functionality update inquiry screen. In the predictive information notification screen, the control unit 6 displays the message “details of update of the functionality “a” to the latest” and displays the influence of the update of the functionality “a”, as well as the “update the functionality “a” button 111 and the “update the functionality “a” and the functionality “b” button 112.

FIG. 10 illustrates a case of the influence of the update of the functionality “a” on the functionality “b” and the functionality “c”. With respect to the functionality “b”, the notification corresponds to a case of insufficient actual-operation records described below and displays a message “The update of the functionality “a” may influence the functionality “b” and the functionality “b” may unsuccessfully operate for actual-operation records are insufficient. In that case, updating the functionality “b” altogether may resolve the issue for actual-operation records are sufficient.” Specifically, the user is notified that actual-operation records for the functionality “b” are insufficient and the functionality “b” may unsuccessfully operate and that updating the functionality “b” altogether may resolve the issue for which actual-operation records are sufficient. With respect to the functionality “c”, the notification corresponds to a case of sufficient actual-operation records described below, displays a message “The update of the functionality “a” influences the functionality “c” and it is highly likely that no issue will arise for actual-operation records are sufficient.” Specifically, the user is notified that actual-operation records for the functionality “a” are sufficient and it is likely that no issue will arise.

The control unit 6 determines whether the operation for the functionality update has been performed (A5). If the control unit 6 determines that a timeout has occurred before the user performs the operation for the functionality update for example (A5: NO), the vehicle process is ended.

If the control unit 6 determines that the user has performed the operation for the functionality update before the timeout (A5: YES), the control unit 6 executes the update of the functionality (A6). Specifically, in response to the user operating the “update the functionality a” button 101, the control unit 6 downloads, installs and activates the software items B, D and E as software corresponding to the functionality “a”. When the user operates the “update functionality a and functionality b” button 102, the control unit 6 downloads, installs and activates A, B, C and E as software applicable to the functionality a and the functionality b.

In response to completion of the update of the functionality, the control unit 6 checks the dysfunction status of the functionality implemented by the updated software (corresponding to a dysfunction check procedure) and generates actual-performance data in which a result of checking the dysfunction status and the software versions of the software items implementing the functionality is linked to each other (corresponding to actual-performance data generation procedure). In the present embodiment, the actual-performance data is generated for the user-selected functionality and the one or more different functionalities influenced by the update of the user-selected functionality. Specifically, where there are the software items B and E common between the functionality “a” and the functionality “b” as described above, if updating the functionality “a” includes updating the software item B and/or the software item E, the control unit 6 generates the actual-performance data pertaining to the functionality “b” in addition to the actual-performance data pertaining to the functionality “a”.

Methods for checking the dysfunction status are expected to be various and may differ between check-target functionalities. Examples of the various expected methods include a method of checking the dysfunction status based on presence/absence of an error occurring during a continuity check such as an API (Application Programming Interface) check for related modules at startup of the functionality, a method of checking the dysfunction status based on presence/absence of an error occurring during the functionality operating after startup, a method of checking the dysfunction status based on presence/absence of an error occurring during the operation in a shadow mode. Depending on the functionalities, an entity that determines the dysfunction status may be other than the control unit 6 and may be, for example, a control unit of an ECU other than the CGW 5. In such cases, the control unit 6 may acquire a result of determining the dysfunction status from other ECUs and may check the dysfunction status based on the result of determining.

Upon generating the actual-performance data, the control unit 6 causes the DCM 4 to transmit an actual-operation record notification signal including the actual-performance data to the OTA center 2 (A7). The control unit 6 determines whether or not the transmission of the actual-operation record notification signals for all the functionalities implemented by the updated software is completed (A8). Specifically, the control unit 6 determines whether or not the transmission of the actual-operation record notification signal for the user-selected functionality and the actual-operation record notification signal for one or more functionalities influenced by the update of the user-selected functionality is completed.

If the control unit 6 determines that the transmission of the actual-operation record notification signal is not completed for all the functionalities (A8: NO), the control unit 6 returns to step S7 to execute step A7 for the functionality for which the transmission of the actual-operation record notification signal is not completed. If the control unit 6 determines that the transmission of the actual-operation record notification signal is completed for all the functionalities (A8: YES), the vehicle process is ended.

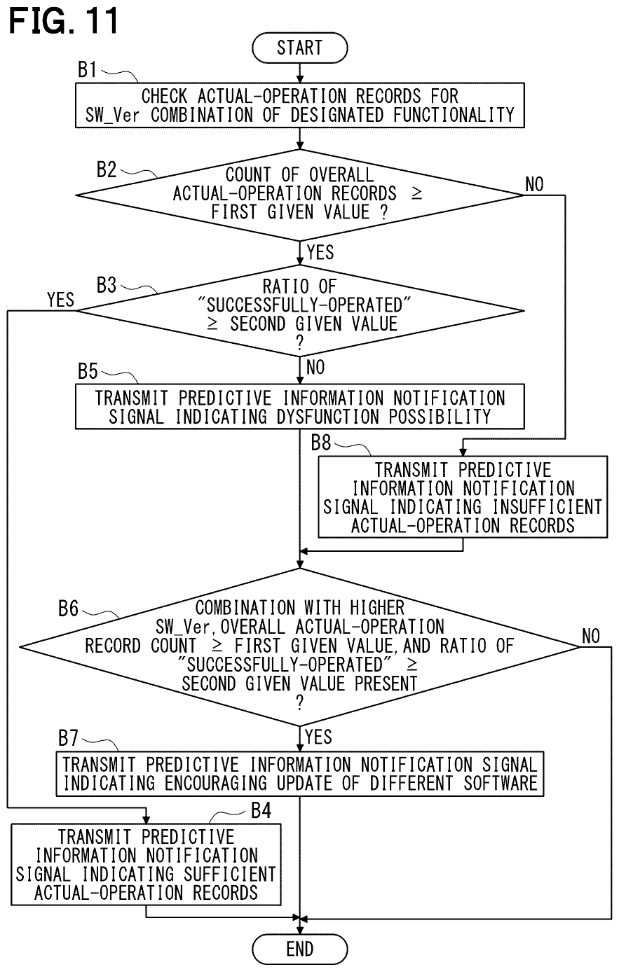

### (2) Center Process Executed by OTA Center 2 (See FIGS. 11 to 13).

As the center process, the OTA center 2 executes the predictive information notification process and the actual-performance database update process. Each process will be described below.

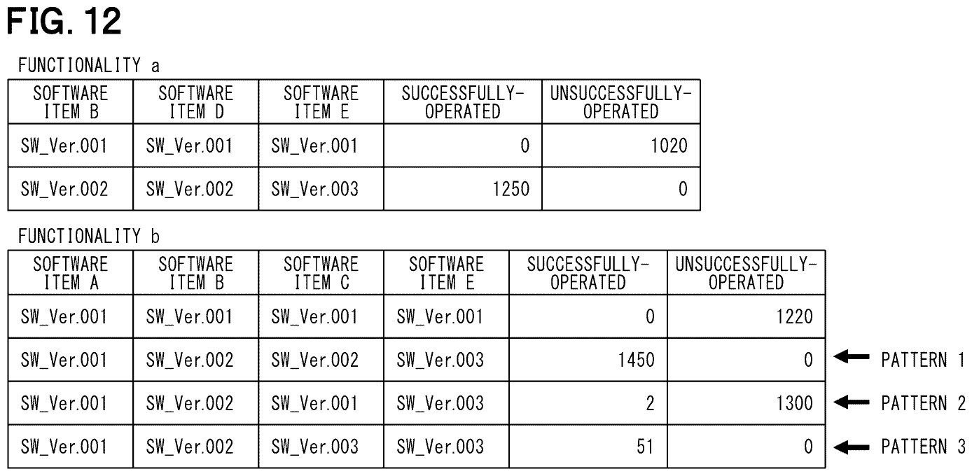

### (2-1) Predictive Information Notification Process (See FIGS. 11 to 12).

In the OTA center 2, upon determining receipt of the inquiry notification signal transmitted from the vehicle system 3, the control unit 21 starts the predictive information notification process. Upon starting the predictive information notification process, the control unit 21 refers to the actual-performance database and checks the actual-operation records for the software version combination of the functionality designated in the inquiry notification signal (B1).

The control unit 21 determines (B2) whether or not a count of overall actual-operation records for the actual-operation-record-check-target functionality is equal to or greater than a first given value (e.g., “100”). Upon determining that the count of overall actual-operation records is greater than or equal to the first given value (B2: YES), the control unit 21 determines whether or not a ratio of actual-operation records “successfully-operated” is greater than or equal to a second given value (e.g., “90%”) (B3). Upon determining that the ratio of actual-operation records “successfully-operated” is greater than or equal to the second given value (B3: YES), the control unit 21 generates the predictive information indicating that the actual-operation records for the functionality are sufficient (corresponding to the predictive information generation procedure), transmits the predictive information notification signal indicating the generated predictive information to the vehicle system 3 (B4, corresponding a predictive information transmission procedure), and ends the predictive information notification process.

If the control unit 21 determines that the ratio of actual-operation records “successfully-operated” is less than the second given value (B3: NO), the control unit 21 generates the predictive information indicative of a possibility that the functionality will have a dysfunction (corresponding to a predictive information generation procedure) and causes the predictive information notification signal indicating the generated predictive information to be transmitted to the vehicle system 3 (B5, corresponding to a predictive information transmission procedure). The control unit 21 refers to the actual-performance database to check for presence of such a combination that: the software version is higher in all relevance; the count of overall actual-operation records is greater than or equal to the first given value; and the ratio of actual-operation records “successfully-operated” is greater than or equal to the second given value (S6).

In detail, the control unit 21 refers to the actual-performance database and checks for presence of a software version combination for the inquiry-target functionality in which the software version of each every software item is equal to or higher than that in the combination designated in the inquiry notification signal and for which the count of overall actual-operation records is greater than or equal to the first given value and the ratio of actual-operation records “successfully-operated” is greater than or equal to the second given value.

If the control unit 21 determines that there is a combination in which the software version is higher in all relevance and for which the count of overall actual-operation records is greater than or equal to the first given value and the ratio of actual-operation records “successfully-operated” is greater than or equal to the second given value (S6: YES), the control unit 21 generates the predictive information indicative of encouraging update of different software to avoid the dysfunction (corresponding to a predictive information generation procedure), and causes a predictive information notification signal indicating the generated predictive information to be transmitted to the vehicle system 3 (B7, corresponds to a predictive information transmission procedure), and ends the predictive information notification process.

If the control unit 21 determines that the count of overall actual-operation records is less than the first given value (B2: NO), the control unit 21 generates the predictive information indicating that the actual-operation records for the functionality are not sufficient (corresponding to a predictive information generation procedure) and causes a predictive information notification signal indicating the generated predictive information to be transmitted to the vehicle system 3 (B8, corresponding to a prediction information transmission procedure). In this case, the control unit 21 performs steps B6 and subsequent thereto as described above and ends the predictive information notification process. The information indicative of encouraging the update of different software to avoid the dysfunction is, for example, information indicative of encouraging the update into the combination of software versions determined in step B6.

Specifically, where the software item combinations are those shown in FIG. 7 for example, there may be a case with respect to the functionality “a” where: the software version of the software item B changes from “Ver. 001” to “Ver. 002”; the software version of the software item D changes from “Ver. 001” to “Ver. 002”; the software version of the software item E changes from “Ver. 001” to “Ver. 003”; and the software version of the software item E changes from “Ver. 001” to “Ver. 003”, and this case will be described with reference to FIG. 12.

If the software versions of the software items B, D, and E implementing the functionality “a” will change as described above, and if the software version of the software A is “Ver. 001” and the software version of the software C is “Ver. 002” at that time, then the software versions of software items A, B, C, and E of the functionality “b” will change into “Ver.001”, “Ver.002”, “Ver.002”, and “Ver.003” due to the update of the functionality “a”. In this case, as shown as “Pattern 1,” the count of overall actual-operation records is greater than or equal to the first given value and the ratio of actual-operation records “successfully-operated” is greater than or equal to the second given value, and therefore, the control unit 21 performs step B4.

If the software versions of the software items B, D, and E implementing the functionality “a” will change as described above, and if the software version of software item A is “Ver. 001” and the software version of software item C is “Ver. 001” at that time, then the software versions of software items A, B, C, and E of the functionality “b” will change into the combination of “Ver. 001”, “Ver. 002”, “Ver. 001”, and “Ver. 003” due to the update of the functionality “a”. In this case, as shown as “Pattern 2,” the count of overall actual-operation records is greater than or equal to the first given value but the ratio of actual-operation records “successfully-operated” is less than the second given value, and therefore, the control unit 21 performs step B5.

If the software versions of software B, D, and E implementing the functionality “a” will change as described above, and if the software version of software A is “Ver. 001” and the software version of software C is “Ver. 003” at that time, then the software versions of software items A, B, C, and E of the functionality “b” will change into the combination of “Ver.001”, “Ver.002”, “Ver.003”, and “Ver.003” due to the update of the functionality “a”. In this case, as shown as “Pattern 3,” the count of overall actual-operation records is less than the first given value, and the control unit 21 performs step B8.

The first given value and the second given value may be fixed or variable. For example, the first given value may be set to a relatively large value for a functionality that is used relatively frequently because relatively more actual-performance data may be acquired, while the first given value may be set to a relatively small value for a functionality that is used relatively infrequently because relatively less actual-performance data may be acquired. For example, the second given value may be set to a variable and may be set to be relatively large for a functionality that requires safety and security, and the second given value may be set to be relatively small for a functionality that requires less safety and security.

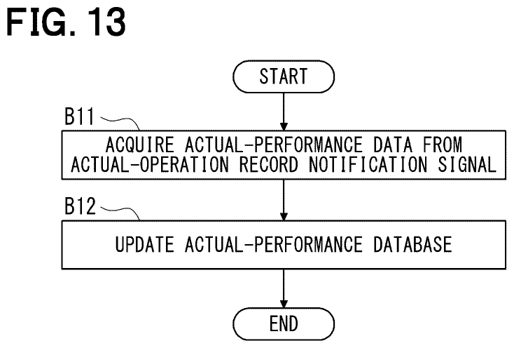

### (2-2) Actual-Performance Database Update Process (See FIG. 13).

In the OTA center 2, when the control unit 21 determines the receipt of the actual-operation record notification signal transmitted from the vehicle system 3, the control unit 21 starts the actual-performance database update process. Upon starting the actual-performance database update process, the control unit 21 acquires the actual-performance data from the actual-operation record notification signal (B11, corresponding to an actual-performance data acquisition procedure). Upon acquiring the actual-performance data, the control unit 21 updates the actual-performance database stored in the actual-performance database storage unit 30 (B12, corresponding to an actual-performance database update procedure) and ends the actual-performance database update process. Specifically, by updating the actual-performance database, the control unit 21 can keep the actual-performance database up-to-date at all times and provide the predictive information reflecting the latest actual-performance database to the vehicle system 3.

In detail, the control unit 21 specifies an update target part of the actual-performance database, wherein the update target part is actual-operation records for the functionality having the software version combination that is linked to the check result in the acquired actual performance record. The control unit 21 increases the count of actual-operation records corresponding to the check result contained in the acquired actual performance data by “1”. In the case of FIG. 7, when the check result “successfully-operated” is linked to such the software version combination of the functionality “a” as “software item B=SW_Ver.002, software item D=SW_Ver.002, software D=SW_Ver.003” in the acquired actual-performance data, the control unit 21 specifies that the update target part is the actual-operation records for the functionality “a” having “Software item B=SW_Ver.002, Software item D=SW_Ver.002, Software item D=SW_Ver.003”, and increases the count of actual-operation records “successfully-operated” from “1250” to “1251” by “1” incrementation.

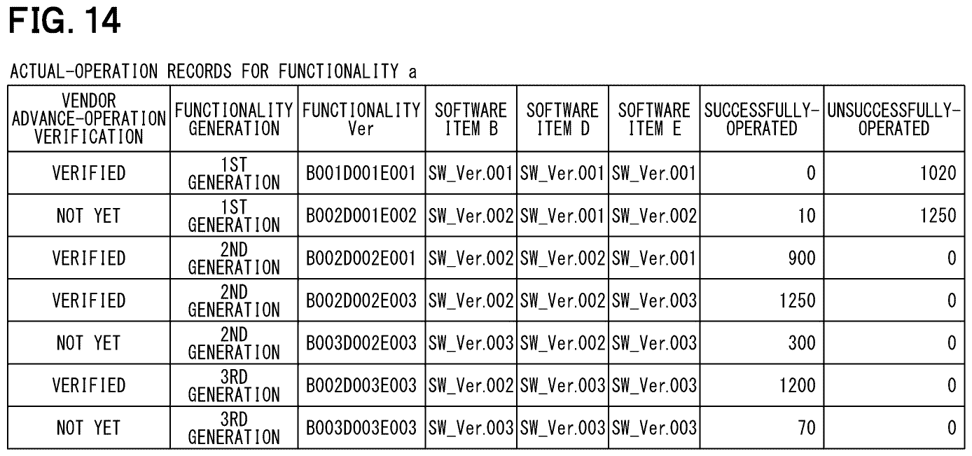

The actual-performance database will be described. As shown in FIG. 14, the control unit 21 of the OTA center 2 may manage the combination of software versions of the software items implementing the functionality along with “vendor's advance-operation-verification”, “functionality generation”, “functionality version” as compared with the example of FIG. 7. FIG. 14 shows an example of the actual-performance database for the functionality “a”.

The “vendor's advance-operation-verification” indicates advance-operation-verification status of the software version combination and indicates whether or not an advance-operation-verification has been executed and whether or not a normal operation has been verified. The control unit 21 registers “unknown” for “vendor's advance-operation-verification” until being notified of the execution of the advance-operation-verification, and registers “verified” or “not yet” upon being notified of the execution of the advance-operation-verification. When the control unit 21 is notified of the execution of the advance-operation-verification indicating that the normal operation has been verified after the advance-operation-verification has been conducted by the vendor and the normal operation has been verified, the control unit 21 registers “verified”. When the control unit 21 is notified of the execution of the advance-operation-verification indicating that the normal operation has not yet been verified after the advance-operation-verification has been conducted by the vendor, the control unit 21 registers “not yet”. The control unit 21 also registers “not yet” when the vendor notifies that the advance-operation-verification has not been conducted because, for example, the vendor is preparing to conduct the advance-operation-verification and has not yet completed it, and the normal operation has not been verified. The normal operation is, for example, operation that ensures safety and security when the vehicle is in motion. The term “vendor” is not limited to companies that manufacture vehicles, but encompasses organizations and groups commissioned by such companies. The “unknown” is registered in “vendor's advance operation verification” in response to, for example, occurrence of a certain event described below in the third embodiment, wherein the certain event is such an event that if a software version combination contained in the actual-operation record notification signal received from the vehicle system 3 is absent in the actual-performance database, the software version combination is added to the actual-performance database.

The “functionality generation” indicates a generation corresponding to a software version of a representative software item in the software version combination. For example, if the software items used for the functionality “a” are the software items B, D, and E, and the representative software item is the software item D, the combinations having the software version “Ver. 001” of the software item D is indicated as the first generation, the combinations having “Ver. 002” are indicated as the second generation, and the combinations having “Ver. 003” is indicated as the third generation. The representative software item may be, for example, a software item selected to be most relevant to the functionality “a” and may be the software item D in the case of FIG. 14, but the software item B or the software item E may also be selected as the representative software item. The above example shows “functionality generation” uniquely identifiable from a combination of software versions but “functionality generation” not uniquely identifiable from a combination of software versions may be used.

The “functionality version” is indicated by a character string of the software version combination for the software items. For example, if the software version combination of software items B, D, and E is “Ver. 001”, “Ver. 001”, and “Ver. 001”, then “B001D001E001”. The above example shows “functionality version” uniquely identifiable from a combination of software versions, but “functionality version” not uniquely identifiable from a combination of software versions may be used.

The control unit 21 registers the functionality generation corresponding to each software version combination in “functionality generation” and the character string in “functionality version”. Specifically, if “functionality generation” and “functionality version” are identifiable from the combination of software versions, the control unit 21 may register the corresponding generation in “functionality generation” and the character string in “functionality version”. On the other hand, if the “functionality generation” and “functionality version” are not identifiable from the combination of software versions, the control unit 21 may register “unknown” in “functionality generation” and “functionality version”. Upon being notified of “functionality generation” and “functionality version” from the vendor, the control unit 21 may register “functionality generation” and “functionality version.” The control unit 21 may omit “functionality generation” and “functionality version” from a management range of the actual-performance database and may not manage “functionality generation” and “functionality version”.

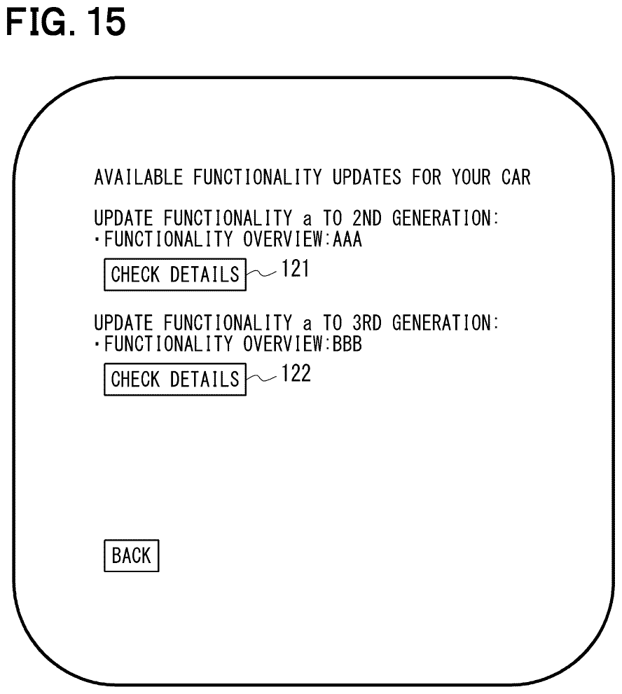

In place of the functionality update inquiry screen shown in FIG. 9, the control unit 6 may display a functionality update inquiry screen shown in FIG. 15. In the functionality update inquiry screen, the control unit 6 displays a message “available functionality updates for your car” and displays a functionality overview for each generation of a functionality, as well as the “check details” buttons 121 to 122. In this case, the user can operate any of the “check details” buttons 201 to 202 to select the update to the generation he/she wishes.

The above-described first embodiment provides following operational effects. In response to updating software, the vehicle system 3 generates actual-performance data in which a check result of dysfunction status pertaining to the functionality implemented by the updated software and the software versions of the software items implementing the functionality are linked to each other. By referring to the actual-performance database, the OTA center 2 generates the predictive information on a prediction of an event that will occur due to the update to the update-planned software item and transmits the predictive information to the vehicle system 3. The OTA center 2 updates the actual-performance database upon acquiring the actual-performance data from the vehicle system 3. The vehicle system 3 presents the predictive information on a prediction of an event that will occur due to the update to the update-planned software item. It is possible to appropriately address dysfunctions that may happen due to inappropriate combinations of software versions.

### Second Embodiment

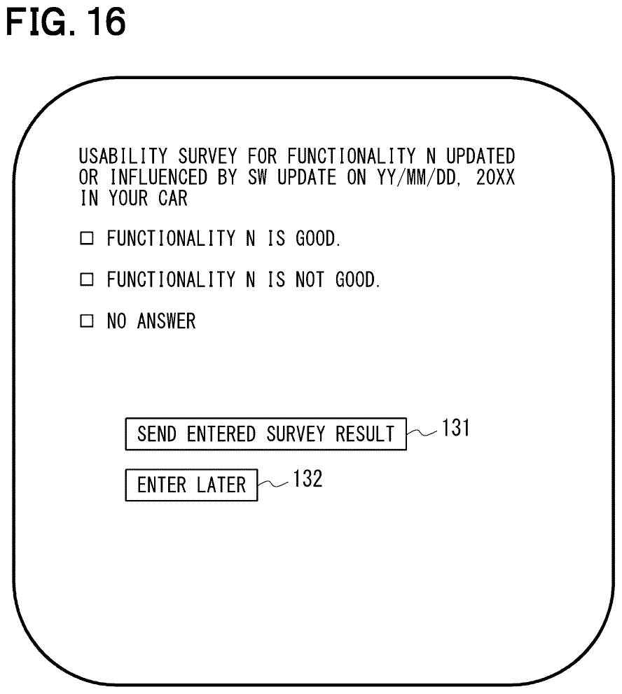

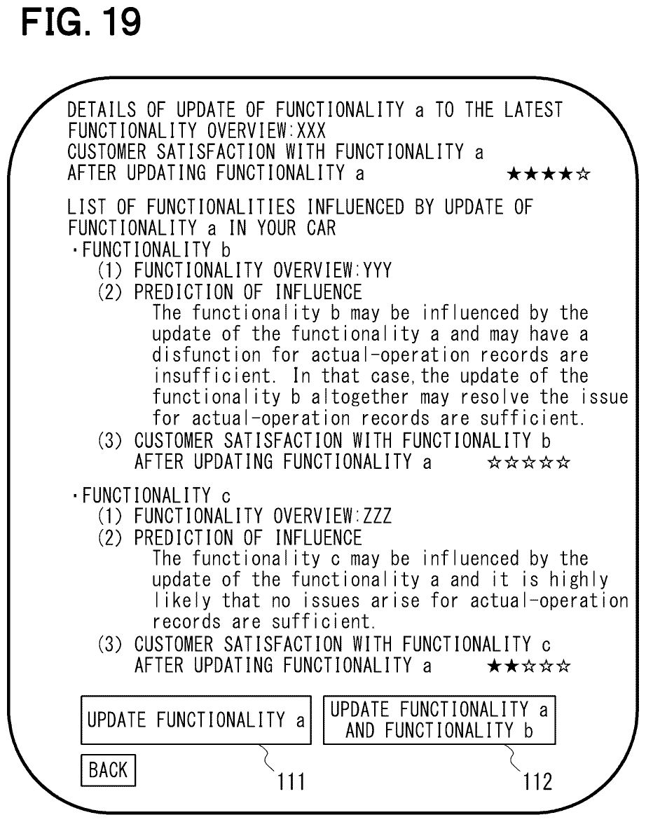

A second embodiment will be described with reference to FIGS. 16 to 19. The second embodiment generates actual-performance data including a check result of user feedback on usability. The control unit 6 of the CGW 5 displays a survey screen shown in FIG. 16 when a given period of time has elapsed since the functionality was updated. On the survey screen, the control unit 6 displays check boxes for “functionality “N” is GOOD,” “functionality “N” is NOT GOOD,” and “No answer” as survey about usability and also displays “send entered survey result” button 131 and “enter later” button 132. The user can provide feedback on the updated software by filling in any of the check boxes and operating the “send entered survey result” button 131.

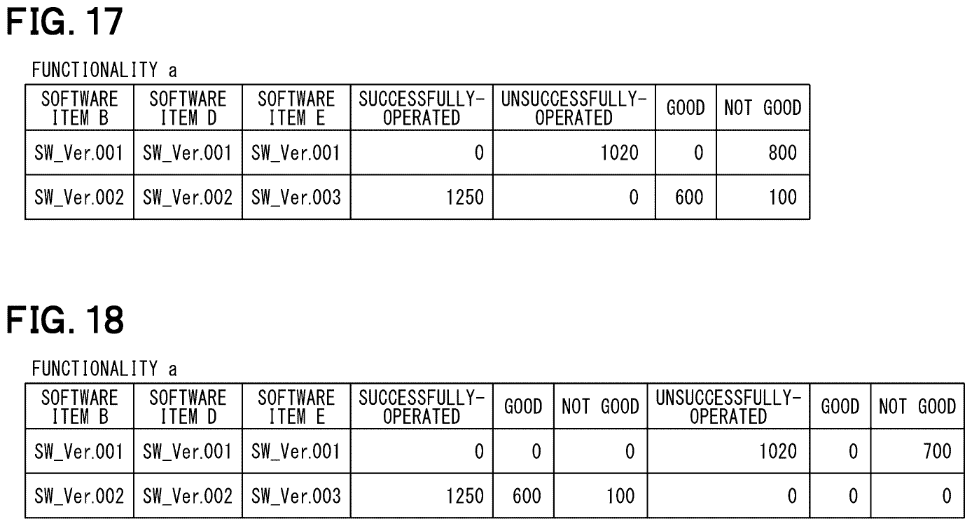

In this case, the actual-performance data managed with respect to the functionality “a” includes, as shown in FIG. 17 for example, the correspondence relationship between its combination of software versions of the software item B, D, and E and whether or not the functionality “a” successfully operated, as well as the information indicating feedback. FIG. 17 shows an example with respect to the functionality “a” in which: “successfully operated” is much less than “unsuccessfully operated” in the combination of software versions “Ver. 001,” “Ver. 001,” and “Ver. 001” of software items B, D, and E, and accordingly the feedback “NOT GOOD” is much larger; and in the combination of software versions “Ver. 002,” “Ver. 002,” and “Ver. 003” of software items B, D, and E, “successfully operated” is much larger than “unsuccessfully operated”, and accordingly, the feedback “GOOD” is much larger. As shown in FIG. 18, the actual-performance data may be managed so that the information indicating feedback in the case of “successfully operated” is managed separately from information indicating feedback in the case of “unsuccessfully operated”.

As shown in FIG. 10, the control unit 6 of the CGW 5 may display user satisfaction with the functionality update by displaying the predictive information notification screen additionally containing “customer satisfaction of functionality “a” after functionality update,” “customer satisfaction of functionality “b” after functionality update,” and “customer satisfaction of functionality “c” after functionality update.”

The above-described second embodiment provides following operational effects. The actual-performance data is generated to include the check result of user feedback on usability. It is possible to appropriately address dysfunctions that may happen due to inappropriate combinations of software versions, taking into account usability.

### Third Embodiment

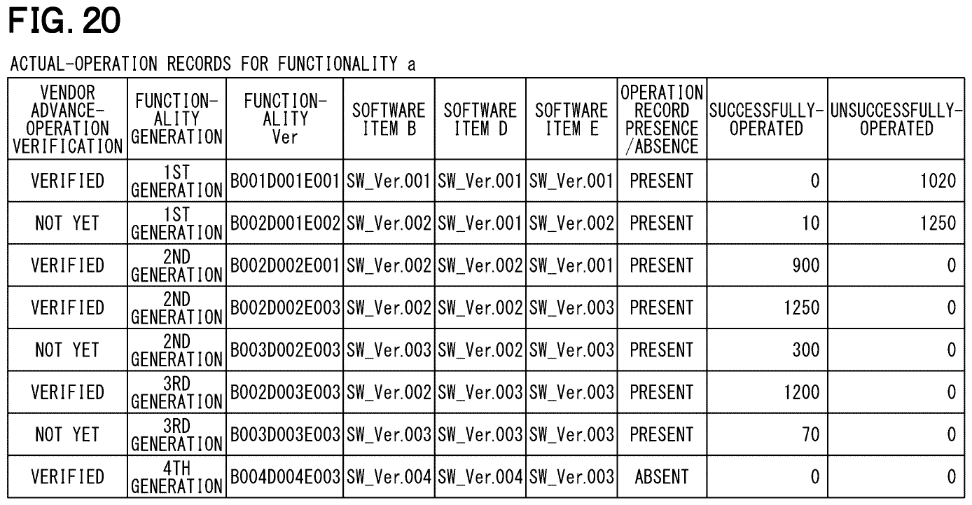

A third embodiment will be described with reference to FIGS. 20 to 24. The third embodiment manages presence and absence of actual-operation records for software. As shown in FIG. 20, the control unit 21 in the OTA center 2 manages the actual-performance data for the functionality “z” further in respect of actual-operation record presence/absence as compared with the example in FIG. 14. The “actual-operation record presence/absence” indicates whether the actual-operation record for the software version combination of the software items is present or absent. Specifically, the “actual-operation record presence/absence” is “presence” for the software version combination for which the actual-operation record notification signal has been acquired from the vehicle system 3 at least once. The “actual-operation record presence/absence” is “absence” for the software version combination for which the actual-operation record notification signal has never been acquired from the vehicle system 3. FIG. 20 shows an example where the “actual-operation record presence/absence” is “absence” for the software version combination “Ver.004”, “Ver.004”, and “Ver.003” of software items B, D, and E for which the “vendor's advance-operation-verification” is “verified”. Also, the “absence” may be registered in the “actual-operation record presence/absence” for the software version combination for which the “vendor's advance-operation-verification” is “unknown” or “not yet”. On condition that the “vendor's advance-operation verification” is “verified”, the “actual-operation record presence/absence” for the software item combination may be registered as “absence”,

The OTA center 2 performs the actual-performance database update process as a center process.

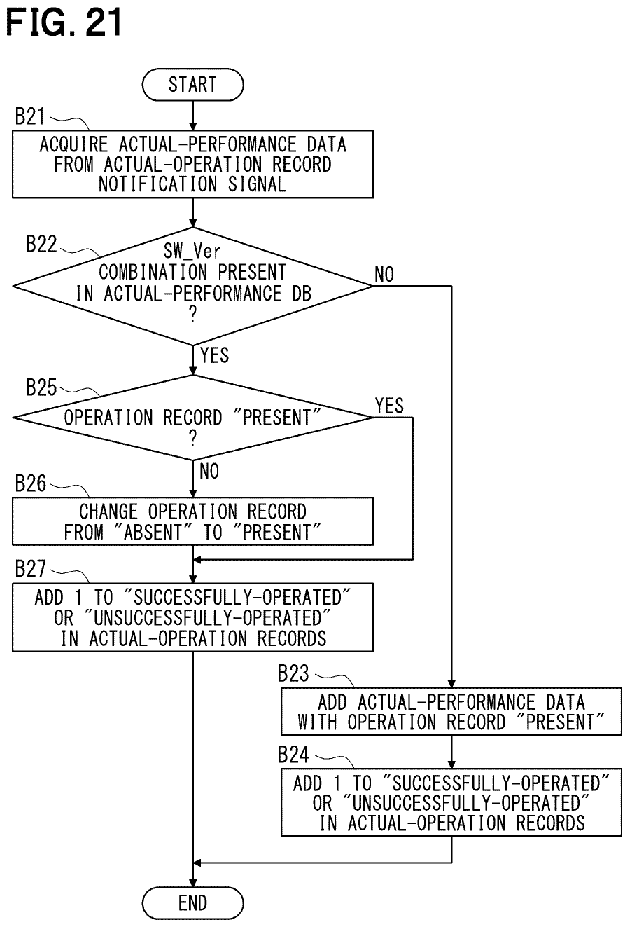

### (2-3) Actual-Performance Database Update Process (See FIG. 21).

When the control unit 21 determines that the actual-operation record notification signal transmitted from the vehicle system 3 has been received, the control unit 21 starts the actual-performance database update process. When the control unit 21 starts the actual-performance database update process, the control unit 21 acquires the actual-performance data from the actual-operation record notification signal (B21, corresponding to an actual-performance data acquisition procedure). After acquiring the actual-performance data, the control unit 21 specifies the software version combination in the acquired actual-performance data and determines whether or not the software version combination in the actual-performance data is present in the actual-performance database (B22).

If the control unit 21 determines that the software version combination in the actual-performance data is absent in the actual-performance database (B22: NO), the control unit 21 adds the software version combination in the actual-performance data as the actual-performance data for the actual-operation record “present” (B23, corresponding to an actual database update procedure) and increases the actual-operation record “successfully-operated” or “unsuccessfully-operated “by 1 (B24, corresponding to an actual database update procedure) and ends the actual-performance database update process.

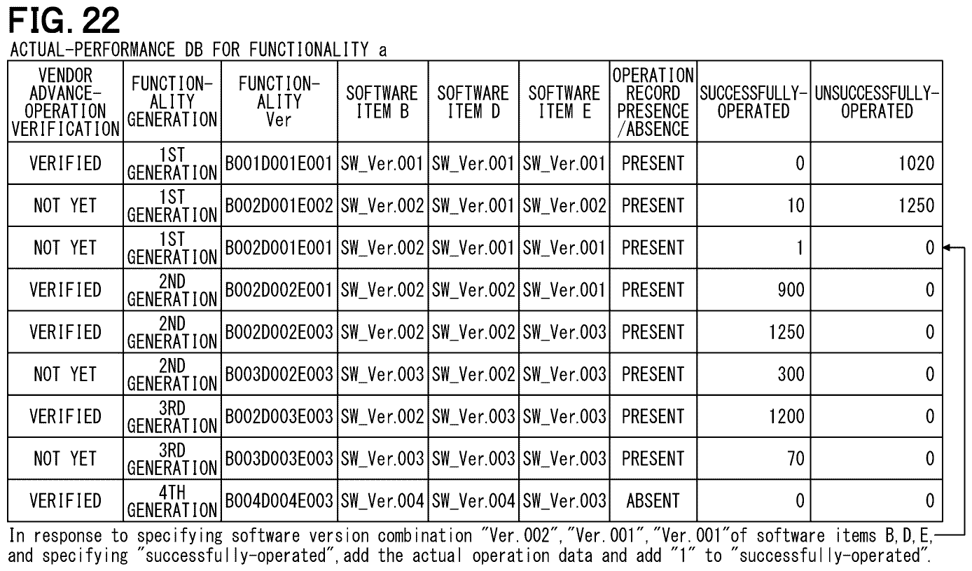

Specifically, where the control unit 21 manages the actual-performance data shown in FIG. 20, if the control unit 21 specifies the combination of software versions of software items B, D, and E “Ver. 002,” “Ver. 001,” and “Ver. 001” as the software version combination in the actual-performance data, the control unit 21 determines that the software version combination is absent, and adds the software version combination in the actual-performance data as the actual-operation record “presence” and increase the actual-operation record “successfully-operated” by 1 upon determining the actual-performance data as “successfully-operated”, as shown in FIG. 22. FIG. 22 shows an example of the actual-operation data “successfully-operated” and increasing the actual-operation record “successfully-operated” by “1”, or alternatively, it increases the actual-operation records “unsuccessfully-operated” by “1” if the actual-operation data is “unsuccessfully-operated”. By determining that the software version combination in the actual-performance data is absent in the actual-performance database, it is possible for the vendor to check operations in un-assumed software version combinations.

Upon determining that the software version combination in the actual-performance data is present in the actual-performance database (B22: YES), the control unit 21 determines whether or not the actual-operation record is present for the software version combination (B25). Upon determining that the actual-operation record for the software version combination is “absent” (B25: NO), the control unit 21 changes the actual-operation record for the actual-performance data from “absent” to “present” (B26, corresponding to an actual-performance database update procedure), adds “1” to the actual-operation record “successfully-operated” or “unsuccessfully-operated” (B27, corresponding to an actual-performance database update procedure), and then ends the actual-performance database update process.

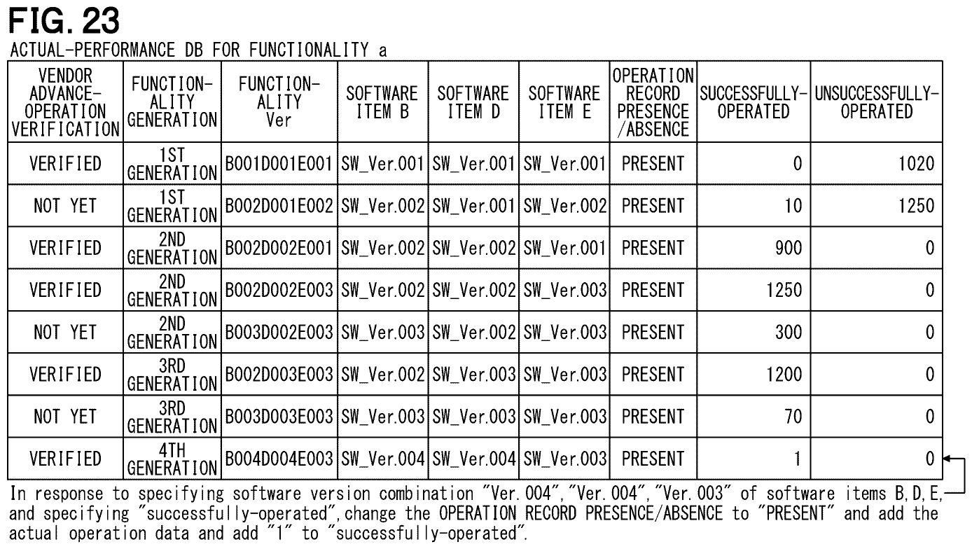

Specifically, where the control unit 21 manages the actual-performance database shown in FIG. 20, if the control unit 21 specifies the combination of software versions of software items B, D, and E “Ver.004”, “Ver.004”, and “Ver.003” as the software version combination in the actual-performance data, the control unit 21 determines that the software version combination is present in the actual-performance database and that the actual-operation record for the software version combination is “absent”, and then changes the actual-operation record from “absent” to “present” for the actual-performance data and increases the actual-operation record “successfully-operated” by “1”, as shown in FIG. 23. FIG. 23 shows an example of the actual-performance data “successfully-operated” and increasing the actual-operation record “successfully-operated” by “1”, or alternatively, it may increase the actual-operation record “successfully-operated” by “1” in the case of the actual-performance data “unsuccessfully-operated”.

Upon determining that the actual-operation record for the software version combination is “present” (B25: YES), the control unit 21 adds “1” to the actual-operation record “successfully” or “unsuccessfully-operated” (B27) and ends the actual-operation database update process.

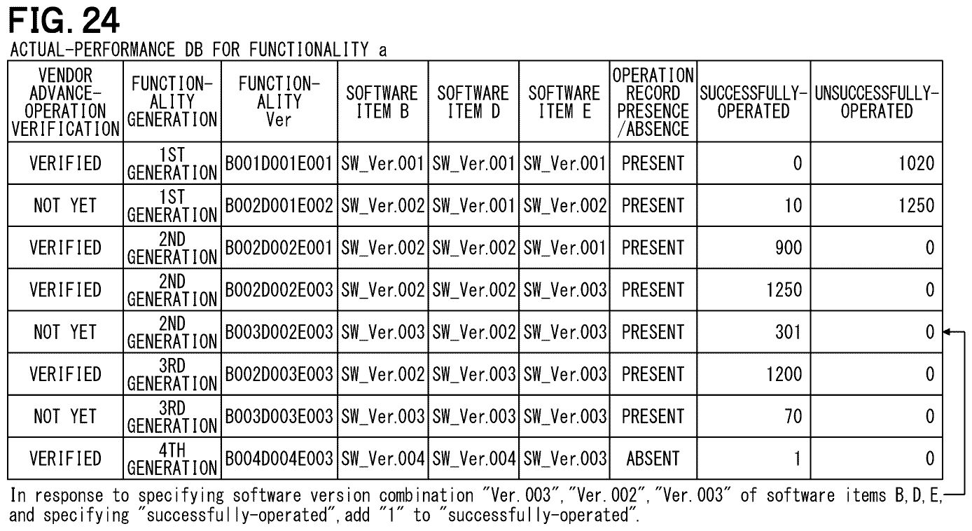

Specifically, where the control unit 21 manages the actual-performance database shown in FIG. 20, if the control unit 21 specifies the combination of software versions of software items B, D, and E “Ver. 003”, “Ver. 002”, and “Ver. 003” as the software version combination in the actual-performance data, the control unit 21 determines that the software version combination is present in the actual-performance database and the actual-operation record for the software version combination is “present”. If the control unit 21 determines that the actual-performance data is “successfully-operated”, the control unit 21 adds “1” to the actual-operation record “successfully-operate”, as shown in FIG. 24. FIG. 24 shown an example of the actual-performance data “successfully-operated” and increasing the actual-operation record “successfully-operated” by “1”, or alternatively, it may increase the actual-operation record “unsuccessfully-operated” by “1” in the case of the actual-performance data “unsuccessfully-operated”.

In the third embodiment described above, when the OTA center 2 acquires from the vehicle system 3 the actual-performance data in which the actual-operation record of the functionality implemented by the updated software and the software versions of the software item implementing the functionality are linked to each other, the OTA center 2 updates the actual-performance database. In the OTA center 2, it is possible to appropriately address dysfunctions that may happen due to inappropriate combinations of software versions.

### Fourth Embodiment

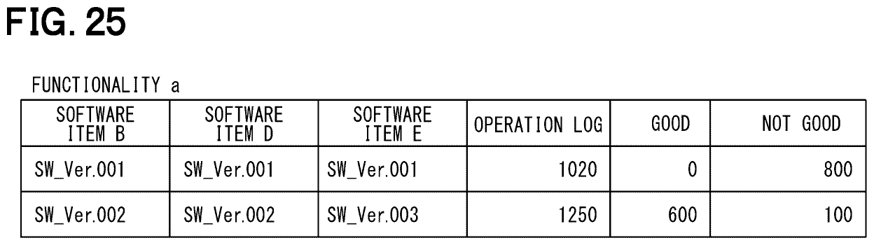

A fourth embodiment will be described with reference to FIG. 9. The fourth embodiment manages operation logs. In the OTA center 2, the control unit 21 cooperates with an operation log database storing the operation logs and manages combinations of software versions of software items implementing a functionality together with the operation logs, as shown in FIG. 25.

The operation logs include a log indicating the dysfunction status pertaining to the functionality implemented by the software. The log indicating the dysfunction status indicates, for example, that the functionality is in an incomplete state with respect to assumed operations thereof, the functionality is in a state of failing to appropriately operate due to a trouble.

The operation logs also include a log indicating operation statuses of multiple processes of the functionality. The process is not limited to a single software item to which one version is assigned. The log indicating operation statuses of multiple processes indicates, for example, operation statuses of screen display and sound output if the functionality has the screen display and the sound output.

In addition, the operation logs include a log indicating the operation status of the functionality in a chronological order. The log indicating the operation status of the functionality in a chronological order indicates, for example, a startup clock time of the functionality, normality or abnormality of the functionality in run-time or operation sequence with respect to each process startup and/or end, and its clock time.

Furthermore, the operation logs include a log indicating an operation status of a different functionality related to the functionality having the dysfunction. The log indicating the operation status of the related different functionality indicates, for example, whether the functionally in which the software item common to the functionality having the dysfunction is used was in operation or in stop at a time of the occurrence of the dysfunction.

The OTA center 2 performs an actual-performance database update process as a center process.

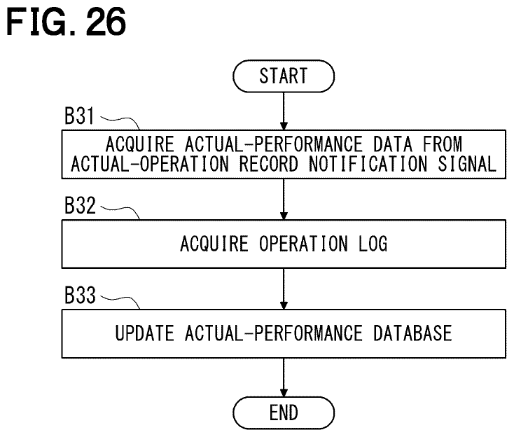

### (2-4) Actual-Performance Database Update Process (See FIG. 26).

When the control unit 21 determines that the actual-operation record notification signal transmitted from the vehicle system 3 has been received, the control unit 21 starts the actual-performance database update process. When the control unit 21 starts the actual-performance database update process, the control unit 21 acquires the actual-performance data from the actual-operation record notification signal (B31, corresponding to an actual-performance data acquisition procedure). When the control unit 21 acquires the actual-performance data, the control unit 21 acquires an operation log from the acquired actual-performance data (B32), updates the actual-performance database stored in the actual-performance database storage unit 30 (B33, corresponding to an actual-performance database update procedure), and ends the actual-performance database update process.

In the fourth embodiment described above, the OTA center 2 acquires from the vehicle system 3 the actual-performance data in which the operation log of the functionality implemented by the updated software and the software versions of the software items implementing the functionality are linked to each other and updates the actual-performance database. In the OTA center 2, it is possible to appropriately check the operation logs of the functionality implemented by the updated software. By analyzing the operation logs, it is possible to determine in what timing an abnormality or failure occurred. In addition, by managing together with information indicating the feedback, it is possible to ascertain that the abnormality or failure indicated in the operation log is relatively highly urgent in the case of relatively high “NOT GOOD” rating and that the abnormality or failure indicated in the operation log is relatively less urgent in the case of relatively less “NOT GOOD” rating.

### Other Embodiments

Although the present disclosure has been described in accordance with the embodiments, it is to be understood that the present disclosure is not limited to such embodiments and structures. The present disclosure also encompasses various modification examples and equivalent modifications. Additionally, various combinations and configurations, as well as other combinations and configurations, including only a single element, more, or less, are also within the scope and spirit of the present disclosure.

Although the OTA center is shown as an example of a vehicle-external device for performing wireless reprogramming and wireless diagnostic services, the vehicle-external device may be, for example, a wired tool which is connected to the CGW via the in-vehicle network in a wired manner for wired reprogramming.

Although an example of utilizing the actual-performance database to generate the predictive information is illustrated, the actual-performance database may be utilized for other uses. For example, the actual-performance database may be utilized to check for the software version combination causing the dysfunction and necessity of improvement.

An illustrated example is such that in response to updating a certain functionality among multiple functionalities of the vehicle, the vehicle system 3 generates the actual-performance data for the certain functionality and the actual-performance data for a different functionality influenced by the update of the certain functionality and transmits these to the OTA center 2. Alternatively, the vehicle system 3 may generate the actual-performance data for each of the multiple functionalities and transmit these to the OTA center 2. The multiple functionalities above include the updated certain functionality and another functionality that have a shared software item. In this configuration also, in response to updating a certain functionality, it is possible to generate the actual-performance data for the certain functionality and the actual-performance data for a different functionality influenced by the update of the certain functionality and transmits these to the OTA center 2.

The OTA center 2 may select, from among the actual performance data of the multiple functionalities transmitted from the vehicle system 3, the actual performance data of the functionality for the software version combination received from the vehicle system 3 for the first time, so that the selected actual performance data is used to update the actual-performance database. For the selection, the OTA center 2 may manage, with respect to the software version combinations of each functionality, whether the actual-performance data has been received from each individual vehicle, by using Vehicle Identification Numbers (VIN). The actual-performance database managed and updated in this way can appropriately provide the actual-operation records of the dysfunction status of multiple vehicles for each software version combination.

The functionality update inquiry screen, the predictive information notification screen, and the survey input screen may be displayed on the in-vehicle display, or may be displayed, for example, on a portable information terminal owned by the user and connected to the OTA center 2 for data communication.

In the vehicle system 3, anti-update protection may be configurable for each functionality. For example, the anti-update protection may be configurable for a function designated by the user. In the vehicle system 3, information on the configuration of the anti-update protection may be stored, for example, in a nonvolatile memory. if the anti-update protection is set for the functionality to which the update is available, this may be displayed when displaying the functionality update inquiry screen in the vehicle system 3. if the anti-update protection is set for the functionality influenced by the update to the user-selected functionality, in other words, if the anti-update protection is set for the functionality of which the software version combination will change due to the update of the user-selected functionality, this may be displayed when displaying the functionality update inquiry screen in the vehicle system 3. By the anti-update protection configurable for each functionality, it is possible to configure the anti-update protection configurable for a favorite functionality when a user does not wish to keep the favorite function up-to-date but wishes to continue using the current functionality with which the user is familiar. For example, updating the software used by the favorite function due to updating another function is avoidable and a change in the usability of the favorite function is avoidable.

For example, the vehicle system 3 may inquire the OTA center 2 about whether there is an available update to the user-designated functionality having the software version combination proven to operate by the actual-operation records or the vendor's advance-operation verification. The software version combination proven to operate by the actual-operation records is the software version combination for which it is determined in step B4 of FIG. 11 that the actual-operation records are sufficient. The software version combination proven to operate by the advance-operation verification is the software version combination for which a record indicating that the operation has been verified in advance by the vendor is registered in the actual-performance database in FIG. 14.

The vehicle system 3 may notify the OTA center 2 of the functionality designated by the user and the current software version combination of the functionality in the vehicle when inquiring the OTA center 2, and the OTA center 2 may specify, from among the actual-performance database, the software version combination of the designated functionality proven to operate by the actual-operation records or the vendor's advance-operation verification and notifies of the update to the specified software version combination as the available update. The notified available updates may include an upgrade and a downgrade, wherein the upgrade changes the software version combination of the functionality to a newer one and the downgrade changes the software version combination to an older one.

When the vehicle system 3 is notified of the available update, the vehicle system 3 may display the function update inquiry screen as shown in FIG. 15, and as a subsequent process, the vehicle system 3 may display the predictive information notification screen and generate the actual-performance data in the same manner as in the embodiments described above. This is because even if the functionality is updated to the combination of software versions proven to operate by the actual-operation records or by the vendor's advance-operation verification, the update may influence a different functionality. If the functionality is updated to the combination of software versions proven to operate by the actual-operation records or by the vendor's advance-operation verification, the performance data for the functionality may not be generated and the performance data for the different functionality influenced by the update may be generated. With this configuration, for example, if a user favorite functionality has a dysfunction after updating various functionalities, the user favorite functionality may be upgraded or downgraded to the combination of software versions proven to operate by the actual-operation records or by the vendor's advance-operation verification.

Apart from the multiple functionalities for which the software updates are performed, the system may also have functionalities that are required to be managed with RxSWIN (Rx Software Identification Number) by regulations. If a user wishes to update a functionality required to be managed with RxSWIN, the predictive information notification screen may be displayed and the actual-performance data may be generated for a different functionality that is influenced by the update and that is not required to be managed with RxSWIN. The updates of functionalities not required to be managed with RxSWIN may be limited to updates that do not change the functionalities required to be managed with RxSWIN into software version combinations other than those certified. These updates may be notified to the vehicle system 3 from the OTA center 2 and displayed as the available updates in the predictive information notification screen.

The control units and methods described in the present disclosure may be implemented by a special purpose computer provided by configuring a memory and a processor programmed to perform one or more functions embodied in a computer program. Alternatively, the control units and methods described in the present disclosure may be implemented by a special purpose computer provided by configuring a processor with one or more dedicated hardware logic circuits. Alternatively, the control units and methods described in the present disclosure may be implemented by one or more special purpose computers provided by configuring a memory and a processor programmed to perform one or more functions in combination with by configuring a processor with one or more hardware logic circuits. The computer program may be stored in a computer-readable non-transitory tangible storage medium as instructions to be executed by a computer.

In addition to claims, the present disclosure also encompasses the following.
<1> A vehicle system (3) in which a plurality of software items in combination implements a functionality includes:
   a dysfunction checker unit (26) that, in response to updating software, checks a dysfunction status pertaining to the functionality implemented by the updated software; and
   an actual-performance data generator unit (28) that generates actual-performance data in which a check result of the dysfunction checker unit and software versions of software items implementing the functionality are linked to each other.
<2> The vehicle system according to <1> further includes: an actual-performance data transmitter unit (29) that causes the actual-performance data generated by the actual-performance data generator unit to be transmitted to a vehicle-external device.
<3> In the vehicle system according to <1> or <2>:
   in response to certain software update for a first functionality, the dysfunction checker unit checks a dysfunction status pertaining to the first functionality and checks a dysfunction status pertaining to a second functionality implemented by software items, a combination of software versions of which has changed due to the certain software update for the first functionality.
<4> In the vehicle system according to any one of <1> to <3>:
   in response to certain software update for a first functionality, the dysfunction checker unit checks dysfunction statuses of a plurality of functionalities including the first functionality.
<5> The vehicle system according to any one of <1> to <4> further includes: a feedback checker unit (27) that checks user feedback on usability in response to updating the software,
   wherein the actual-performance data generator unit generates the actual-performance data in which the check result of the dysfunction checker unit, a check result of the feedback checker unit and the software versions of the software items implementing the functionality are linked to each other.
<6> A vehicle-external device (2) that manages software items for implementing a functionality in a vehicle system includes:
   an actual-performance database storage unit (30) that stores an actual-performance database including actual-performance data of a plurality of vehicles such that the actual-performance data of a respective vehicle indicates a correspondence between a combination of software versions of software items implementing a functionality in the vehicle system and a dysfunction status pertaining to the functionality;
   a predictive information generator unit (33) that refers to the actual-performance database to generate predictive information on a prediction of an event that will occur due to an update to an update-planned software item; and
   a predictive information transmitter unit (34) that causes the predictive information generated by the predictive information generator unit to be transmitted to the vehicle system.
<7> The vehicle-external device according to <6> further includes:
   an overall actual-operation record count deriver unit (31) that derives a count of overall actual-operation records in the actual-performance database.
<8> The vehicle-external device according to <6> or <7> further includes: an actual-operation record ratio deriver unit (32) that derives a ratio of a count of actual-operation records indicative of dysfunction absence or a ratio of a count of actual-operation records indicative of dysfunction presence in the actual-performance database.
<9> In the vehicle-external device according to any one of <6> to <8>:
   as the predictive information, the predictive information generator unit generates information indicating that the functionality implemented by the update-planned software item will operate normally or information indicating a possibility that the functionality implemented by the update-planned software item will have a dysfunction.
<10> In the vehicle-external device according to any one of <6> to <9>:
   as the predictive information, the predictive information generator generates information indicating a possibility that the functionality implemented by the update-planned software item will have a dysfunction, together with information indicative of encouraging a different software update for avoiding the dysfunction.
<11> In the vehicle-external device according to any one of <6> to <10>:
the predictive information generator unit generates information indicating user feedback on usability as the predictive information.
<12> A vehicle-external device that manages software items for implementing a functionality in a vehicle system includes:
   an actual-performance database storage unit (30) that stores an actual-performance database including actual-performance data of a plurality of vehicles such that the actual-performance data of a respective vehicle indicates a correspondence between a combination of software versions of software items implementing a functionality in the vehicle system and a dysfunction status pertaining to the functionality;
   an actual-performance data acquirer unit (35) that, from the vehicle system, acquires actual-performance data in which a check result of dysfunction status pertaining to a functionality implemented by updated software and software versions of software items implementing the functionality are linked to each other; and
   an actual-performance database updater unit (36) that updates the actual-performance database when the actual-performance data is acquired by the actual-performance data acquirer unit.
<13> In the vehicle-external device according to <12>:
   the actual-performance database updater unit updates the actual-performance database based on the actual-performance data indicating that a combination of the software versions has changed.
<14> In the vehicle-external device according to <12> or <13>:
   along with information indicative of whether a combination of software versions has been verified by advance-operation-verification, the actual-performance data is stored in the actual-performance database of the actual-performance database storage unit.
<15> In the vehicle-external device according to any one of <12> to <14>:
   the actual-performance database storage unit stores the actual-performance database including the actual-performance data of the plurality of vehicles such that the actual-performance data of a respective vehicle indicates a correspondence between: the combination of software versions of software items implementing the functionality in the vehicle system; the dysfunction status pertaining to the functionality; and information indicating user feedback on usability.
<16> A vehicle system (3) in which a plurality of software items in combination implements a functionality includes:
   a predictive information presenter unit (37) that presents predictive information on a prediction of an event that will occur due to an update to an update-planned software item.
<17> In the vehicle system according to <16>:
   as the predictive information, the predictive information presenter unit presents information indicating that the functionality implemented by the update-planned software item will operate normally or information indicating a possibility that the functionality implemented by the update-planned software item will have a dysfunction.
<18> In The vehicle system according to <16> or <17>:
   as the predictive information, the predictive information presenter unit presents information indicating a possibility that the functionality implemented by the update-planned software item will have a dysfunction, together with information indicative of encouraging a different software update for avoiding the dysfunction.
<19> In The vehicle system according to any one of <16> to <18>:
   as the predictive information, the predictive information presenter unit presents information indicating user feedback on usability.
<20> A data communication system (1) includes:
   a vehicle system (3) in which a plurality of software items in combination implements a functionality; and
   a vehicle-external device (2) that manages the software items implementing the functionality in the vehicle system,
   the vehicle system including:
   a dysfunction checker unit (26) that, in response to updating software, checks a dysfunction status pertaining to the functionality implemented by the updated software; and
   an actual-performance data generator unit (28) that generates actual-performance data in which a check result of the dysfunction checker unit and software versions of software items implementing the functionality are linked to each other,
   the vehicle-external device including:
   an actual-performance database storage unit (30) that stores an actual-performance database including actual-performance data of a plurality of vehicles such that the actual-performance data of a respective vehicle indicates a correspondence between a combination of software versions of software items implementing a functionality in the vehicle system and a dysfunction status pertaining to the functionality;
   an actual-performance data acquirer unit (35) that, from the vehicle system, acquires actual-performance data in which a check result of dysfunction status pertaining to a functionality implemented by updated software and software versions of software items implementing the functionality are linked to each other; and
   an actual-performance database updater unit (36) that updates the actual-performance database when the actual-performance data is acquired by the actual-performance data acquirer unit.
<21> In the data communication system according to <20>:
   the vehicle-external device further includes:
   an actual-performance data acquirer unit (35) that, from the vehicle system, acquires actual-performance data in which a check result of dysfunction status pertaining to a functionality implemented by updated software and software versions of software items implementing the functionality are linked to each other; and
   an actual-performance database updater unit (36) that updates the actual-performance database when the actual-performance data is acquired by the actual-performance data acquirer unit.
<22> In the data communication system according to <20> or <21>:
   the vehicle system further includes:
   a predictive information presenter unit (37) that presents predictive information on a prediction of an event that will occur due to an update to an update-planned software item.
<23> A vehicle-external device (2) that performs management of software items for implementing a functionality in a vehicle system includes:
   an actual-performance database storage unit (30) that stores an actual-performance database including actual-performance data of a plurality of vehicles such that the actual-performance data of a respective vehicle indicates a correspondence between a combination of software versions of software items implementing a functionality in the vehicle system and an actual-operation record of the functionality in the vehicle system;
   an actual-performance data acquirer unit (35) that, from the vehicle system, acquires actual-performance data in which an actual-operation record of the functionality implemented by updated software and a combination of software versions of software items implementing the functionality are linked to each other; and
   an actual-performance database updater unit (36) that updates the actual-performance database when the actual-performance data is acquired by the actual-performance data acquirer unit.
<24> In the vehicle-external device according to <23>:
   if the combination of the software versions of the software items in the actual-performance data is a combination of software versions not stored in the actual-performance database, the actual-performance database updater unit performs the management via adding the combination of the software versions of the software items in the actual-performance data.
<25> In the vehicle-external device according to <23> or <24>:
   the actual-performance database updater unit stores the actual-performance database by linking the actual-operation record to an advance-operation-verification status.
<26> A vehicle-external device (2) that manages software items for implementing a functionality in a vehicle system includes:
   an actual-performance database storage unit (30) that stores an actual-performance database including actual-performance data of a plurality of vehicles such that the actual-performance data of a respective vehicle indicates a correspondence between a combination of software versions implementing a functionality in the vehicle system and an operation log of the functionality in the respective vehicle; and
   an actual-performance data acquirer unit (35) that, from the vehicle system, acquires actual-performance data in which an operation log of the functionality implemented by updated software and software versions of software items implementing the functionality are linked to each other; and
   an actual-performance database updater unit (36) that updates the actual-performance database when the actual-performance data is acquired by the actual-performance data acquirer unit.
<27> In the vehicle-external device according to <26>:
   the operation log includes at least one of: a log indicative of dysfunction status pertaining to the functionality implemented by software; a log indicative of operation status of a plurality of processes providing the functionality; a log indicative of operation status of the functionality in a chronological order; and a log indicative of a different functionality related to the functionality having a dysfunction.
<28> In the vehicle-external device according to <26> or <27>:
   the actual-performance database storage unit stores the actual-performance database by linking the operation log to information indicating user feedback on usability.

What is claimed is:

1. A vehicle system in which a plurality of software items in combination implements a functionality, comprising:
at least one computer including a processor that executes a computer program and/or a dedicated circuit,
wherein the computer is configured to:
in response to updating software, check a dysfunction status pertaining to the functionality implemented by the updated software; and
generate actual-performance data in which a check result of the dysfunction status and software versions of the software items implementing the functionality are linked to each other.

2. The vehicle system according to claim 1, wherein:
the computer causes the generated actual-performance data to be transmitted to a vehicle-external device.

3. The vehicle system according to claim 1, wherein:
in response to certain software update for a first functionality, the computer checks a dysfunction status pertaining to the first functionality and checks a dysfunction status pertaining to a second functionality implemented by software items, a combination of software versions of which has changed due to the certain software update for the first functionality.

4. The vehicle system according to claim 1, wherein:
in response to certain software update for a first functionality, the computer checks dysfunction statuses of a plurality of functionalities including the first functionality.

5. The vehicle system according to claim 1, wherein:
the computer checks user feedback on usability in response to updating the software,
wherein the computer generates the actual-performance data in which the check result of the dysfunction status, a check result of the user feedback and the software versions of the software items implementing the functionality are linked to each other.

6. A vehicle-external device that manages software items for implementing a functionality in a vehicle system, comprising:
at least one computer including a processor that executes a computer program and/or a dedicated circuit,
wherein the computer is provided with an actual-performance database storage that stores an actual-performance database including actual-performance data of a plurality of vehicles such that the actual-performance data of a respective vehicle indicates a correspondence between a combination of software versions of software items implementing a functionality in the vehicle system and a dysfunction status pertaining to the functionality,
wherein the computer is configured to:
refer to the actual-performance database to generate predictive information on a prediction of an event that will occur due to an update to an update-planned software item; and
cause the generated predictive information to be transmitted to the vehicle system.

7. The vehicle-external device according to claim 6, wherein:
the computer derives a count of overall actual-operation records in the actual-performance database.

8. The vehicle-external device according to claim 6, wherein:
the computer derives a ratio of a count of actual-operation records indicative of dysfunction absence or a ratio of a count of actual-operation records indicative of dysfunction presence in the actual-performance database.

9. The vehicle-external device according to claim 6, wherein:
as the predictive information, the computer generates information indicating that the functionality implemented by the update-planned software item will operate normally or information indicating a possibility that the functionality implemented by the update-planned software item will have a dysfunction.

10. The vehicle-external device according to claim 6, wherein:
as the predictive information, the computer generates information indicating a possibility that the functionality implemented by the update-planned software item will have a dysfunction, together with information indicative of encouraging a different software update for avoiding the dysfunction.

11. The vehicle-external device according to claim 6, wherein:
the computer generates information indicating user feedback on usability as the predictive information.

12. A vehicle-external device that manages software items for implementing a functionality in a vehicle system, comprising:
at least one computer including a processor that executes a computer program and/or a dedicated circuit,
wherein the computer is provided with an actual-performance database storage that stores an actual-performance database including actual-performance data of a plurality of vehicles such that the actual-performance data of a respective vehicle indicates a correspondence between a combination of software versions of software items implementing a functionality in the vehicle system and a dysfunction status pertaining to the functionality,
wherein the computer is configured to:
from the vehicle system, acquire actual-performance data in which a check result of dysfunction status pertaining to a functionality implemented by updated software and software versions of software items implementing the functionality are linked to each other; and
update the actual-performance database when the actual-performance data is acquired from the vehicle system.

13. The vehicle-external device according to claim 12, wherein:
the computer updates the actual-performance database based on the actual-performance data indicating that a combination of the software versions has changed.

14. The vehicle-external device according to claim 12, wherein:
along with information indicative of whether a combination of software versions has been verified by advance-operation-verification, the actual-performance data is stored in the actual-performance database of the actual-performance database storage.

15. The vehicle-external device according to claim 12, wherein:
the actual-performance database storage stores the actual-performance database including the actual-performance data of the plurality of vehicles such that the actual-performance data of a respective vehicle indicates a correspondence between: the combination of software versions of software items implementing the functionality in the vehicle system; the dysfunction status pertaining to the functionality; and information indicating user feedback on usability.

16. A vehicle system in which a plurality of software items in combination implements a functionality, comprising:
at least one computer including a processor that executes a computer program and/or a dedicated circuit,
wherein the computer is configured to:
present predictive information on a prediction of an event that will occur due to an update to an update-planned software item.

17. The vehicle system according to claim 16, wherein:
as the predictive information, the computer presents information indicating that the functionality implemented by the update-planned software item will operate normally or information indicating a possibility that the functionality implemented by the update-planned software item will have a dysfunction.

18. The vehicle system according to claim 16, wherein:
as the predictive information, the computer presents information indicating a possibility that the functionality implemented by the update-planned software item will have a dysfunction, together with information indicative of encouraging a different software update for avoiding the dysfunction.

19. The vehicle system according to claim 16, wherein:
as the predictive information, the computer presents information indicating user feedback on usability.

20. A data communication system comprising:
a vehicle system in which a plurality of software items in combination implements a functionality; and
a vehicle-external device that manages the software items implementing the functionality in the vehicle system,
wherein each of the vehicle system and the vehicle-external device includes a least one computer including a processor that executes a computer program and/or a dedicated circuit,
the vehicle system is configured to:
in response to updating software, check a dysfunction status pertaining to the functionality implemented by the updated software; and
generate actual-performance data in which a check result of the dysfunction status and software versions of the software items implementing the functionality are linked to each other,
the vehicle-external device is provided with:
an actual-performance database storage that stores an actual-performance database including actual-performance data of a plurality of vehicles such that the actual-performance data of a respective vehicle indicates a correspondence between a combination of software versions of software items implementing a functionality in the vehicle system and a dysfunction status pertaining to the functionality, and
the vehicle-external device is configured to:
from the vehicle system, acquire actual-performance data in which a check result of dysfunction status pertaining to a functionality implemented by updated software and software versions of software items implementing the functionality are linked to each other; and
update the actual-performance database when the actual-performance data is acquired from the vehicle system.

21. The data communication system according to claim 20, wherein
the vehicle-external device is configured to:
from the vehicle system, acquires actual-performance data in which a check result of dysfunction status pertaining to a functionality implemented by updated software and software versions of software items implementing the functionality are linked to each other; and
update the actual-performance database when the actual-performance data is acquired from the vehicle system.

22. The data communication system according to claim 20, wherein
the vehicle system is configured to:
present predictive information on a prediction of an event that will occur due to an update to an update-planned software item.

23. A vehicle-external device that performs management of software items for implementing a functionality in a vehicle system, comprising:
at least one computer including a processor that executes a computer program and/or a dedicated circuit,
wherein the vehicle-external device is provided with:
an actual-performance database storage that stores an actual-performance database including actual-performance data of a plurality of vehicles such that the actual-performance data of a respective vehicle indicates a correspondence between a combination of software versions of software items implementing a functionality in the vehicle system and an actual-operation record of the functionality in the vehicle system,
wherein the vehicle-external device is configured to:
from the vehicle system, acquire actual-performance data in which an actual-operation record of the functionality implemented by updated software and a combination of software versions of software items implementing the functionality are linked to each other; and
update the actual-performance database when the actual-performance data is acquired from the vehicle system.

24. The vehicle-external device according to claim 23, wherein
if the combination of the software versions of the software items in the actual-performance data is a combination of software versions not stored in the actual-performance database, the computer performs the management via adding the combination of the software versions of the software items in the actual-performance data.

25. The vehicle-external device according to claim 23, wherein
the actual-performance database storage stores the actual-performance database by linking the actual-operation record to an advance-operation-verification status.

26. A vehicle-external device that manages software items for implementing a functionality in a vehicle system, comprising:
at least one computer including a processor that executes a computer program and/or a dedicated circuit,
wherein the vehicle-external device is provided with:
an actual-performance database storage that stores an actual-performance database including actual-performance data of a plurality of vehicles such that the actual-performance data of a respective vehicle indicates a correspondence between a combination of software versions implementing a functionality in the vehicle system and an operation log of the functionality in the respective vehicle,
wherein the vehicle-external device is configured to:
from the vehicle system, acquire actual-performance data in which an operation log of the functionality implemented by updated software and software versions of software items implementing the functionality are linked to each other; and
update the actual-performance database when the actual-performance data is acquired from the vehicle system.

27. The vehicle-external device according to claim 26, wherein
the operation log includes at least one of: a log indicative of dysfunction status pertaining to the functionality implemented by software; a log indicative of operation status of a plurality of processes providing the functionality; a log indicative of operation status of the functionality in a chronological order; and a log indicative of a different functionality related to the functionality having a dysfunction.

28. The vehicle-external device according to claim 26, wherein
the actual-performance database storage stores the actual-performance database by linking the operation log to information indicating user feedback on usability.
